(19) United States
(12) Patent Application Publication
(10) Pub. No.: US 2026/0241641 A1
(43) Pub. Date: Aug. 20, 2026

(54) APPARATUS AND PROCESS FOR MANUFACTURING A MEDICAL DEVICE AT POINT OF CARE

(71) Applicant: METICULY COMPANY LIMITED, Bangkok 10330 (TH)

(72) Inventors: Thanawat Phetrattanarangsi, Bangkok (TH); Thanachai Boonchuduang, Bangkok (TH); Pattarapong Wannapraphai, Bangkok (TH); Kanin Sirichatchai, Bangkok (TH); Natthaphat Viriya, Bangkok (TH)

(73) Assignee: METICULY COMPANY LIMITED, Bangkok 10330 (TH)

(21) Appl. No.: 19/161,975

(22) PCT Filed: Mar. 1, 2024
(86) PCT No.: PCT/IB2024/051985

§ 371 Date: Sep. 3, 2025

Related U.S. Application Data
(60) Provisional application No. 63/449,798, filed on Mar. 3, 2023.

(51) Int. Cl. B29C 64/35; B22F 10/68; B22F 12/86; B29C 64/393; B33Y 30/00; B33Y 40/20; B33Y 50/02

(52) U.S. Cl. CPC B29C 64/35; B22F 10/68; B22F 12/86; B29C 64/393; B33Y 30/00; B33Y 40/20; B33Y 50/02

(57) ABSTRACT

An apparatus includes production modules, an integrating element, and inspection gates. The production modules are configured to process the medical device, a medical device part, a medical device accessory, a medical device preform, or a raw material. The integrating element is configured to, between any two of the at least two production modules, move the medical device, the medical device part, the medical device accessory, or the medical device preform. The inspection gates are configured to, outside the at least two production modules, subject the medical device, the medical device part, the medical device accessory, or the medical device preform, to an inspection technique according to a predetermined inspection mode. The operations of the production modules, the integrating element, and the inspection gates are administered by a controlling software.

### FIELD OF THE INVENTION

The present invention relates to the manufacture of medical device, particularly the partially or fully automated manufacture of medical device, and also particularly the manufacture of medical device that may benefit from customization.

### BACKGROUND OF THE INVENTION

Partially or fully automated manufacture of medical device has been developed to address many technical problems, particularly those related to the medical devices of which customization impacts the treatment outcome. Notable examples of such devices include medical implants and other invasive medical devices. Their customization imparts greater precision and patient specificity; yet the customization also introduces logistical issues: time required to fabricate such precision devices and the physical distance between the client (e.g., the surgeon) and the specialized manufacturer. Both time and distance in turn impact the treatment outcomes. Examples of the prior arts directed to the solution of this problem include the following.

U.S. Pat. No. 10,453,158 B2 teaches the systems and methods for producing medical devices, such as customized medical-grade labels, medical kits and other medical devices having customizable features. Further, U.S. Pat. No. 7,983,777 B2 discloses the automated systems and methods for creating and obtaining devices, including biomedical implants. These prior arts rely upon the communication between the client and the manufacturer over an information network, including the internet. Both arts substantially reduce the time factor; though the medical devices manufactured from both arts must still be delivered via conventional postal services to the client.

Moreover, U.S. Pat. No. 10,407,897 B2 discloses the systems and design of medical container unit for designing and/or manufacturing an implant. This prior art addresses the distance factor but due to its being substantially non-automated, it is inadequate for resolving the time factor.

Accordingly, there is a longstanding yet unsatisfied demand to solve the foregoing logistical issue in the manufacture of medical devices.

### SUMMARY OF THE INVENTION

An object of the present invention is to provide an apparatus and a process for manufacturing a medical device which effectively addresses both the time and distance factors underlying the logistical problem persisting in the relevant arts. Also, an object of the present invention is to provide such apparatus and process that can overcome the key technical problems which prevent or greatly discourage implementation of the apparatus and process of this nature at the clinical facility or point of care, which would effectively address the distance factor.

Conceptually, the present invention may be embodied in an apparatus comprising a plurality of production modules (PMs) that are inter-connected by integrating elements (IEs) and inspection gates (IGs), synergistically administered by a controlling software (CS). Such an embodiment is effective in minimizing the lags occurring in an apparatus or process operating under the conventional standards of medical device industries. Moreover, the embodiment's modular construction allows itself to be installed and to operate in an effectively minimized/compact area, particularly at a clinical facility or point of care. The same modular construction allows an embodiment to be moved with ease from one site to another.

Also conceptually, the present invention may be embodied in a process which employs the synergy of a plurality of PMs, IEs, IGs, and CS to carry out the manufacture of medical device entirely at a clinical facility or point of care.

Also conceptually, an embodiment is capable of manufacturing medical devices on demand in broad ranges of types, sizes, and models. In comparison with the conventional apparatus and processes, this reduces the clinical facility's waiting time, risks arising from transportation, and burden of handling and storage. This also allows the physician/surgeon to exert a greater control over the medical device's specification that will eventually benefit the treatment.

In the first aspect, an embodiment is an apparatus for manufacturing a medical device. Said apparatus comprises at least two production modules, at least one integrating element, and at least two inspection gates. The at least two production modules are independently configured to process the medical device, a medical device part, a medical device accessory, a medical device preform, or a raw material. The integrating element is configured to, between any two of the at least two production modules, move the medical device, the medical device part, the medical device accessory, or the medical device preform. And the at least two inspection gates are independently configured to, outside the at least two production modules, subject the medical device, the medical device part, the medical device accessory, or the medical device preform, to an inspection technique according to a predetermined inspection mode. Further, the operations of said at least two production modules, said integrating element, and said at least two inspection gates, are administered by a controlling software. Furthermore, the said apparatus is constructed as a ready-to-transport compact unit.

In such an embodiment, it is preferred that each of the at least two inspection gates is sequenced between any two of the said at least two production modules. It is more preferred that one of the at least two inspection gates is sequenced between two of the said at least two production modules, said two of the said at least two production modules being independently configured to process the medical device, the medical device part, the medical device accessory, the medical device preform, or the raw material, by performing a production technique that is independently selectable from any one or more of following group: additive manufacturing, part extraction, surface treatment, thermal or chemical treatment, surface finishing, quality control, and labeling or packing.

In such an embodiment, it is preferred that each of the said at least two production modules is independently configured to process the medical device, the medical device part, the medical device accessory, the medical device preform, or the raw material, by performing a production technique. The said production technique is independently selectable from any one or more of following groups: a first group, comprising additive manufacturing, part extraction, surface treatment, cleaning, thermal or chemical treatment, and surface finishing; a second group, comprising quality control; and a third group, comprising sterilization, and labeling or packing.

By the abovementioned “independently selectable”, and any similar terms used in association with a technique or the nature of any feature or element, is not limited to the selection of one. Unless specified otherwise, selection from a group of subjects may refer to selecting one or several subjects from that group. The possibilities include an embodiment wherein one production module is configured to perform a plurality of different production techniques, and an embodiment wherein a plurality of the production modules are configured to perform the same production technique.

The at least two production modules may be positioned in any order; regardless, the present inventors found certain orders which were particularly advantageous.

Preferably, when two or more of the at least two production modules are independently configured to perform two or more production techniques selected from different groups, then the said two or more of the at least two or more production modules are sequenced so that: (i) the production techniques from the first group are always performed before the production technique from the second group and before the production techniques from the third group, and/or (ii) the production technique from the second group is always performed before the production techniques from the third group, and when two or more of the at least two production modules are independently configured to perform two or more production techniques selected from the same group, then the said two or more of the at least two production modules may be sequenced in any order.

Optionally, an embodiment may comprise at least four of the production modules independently configured to perform at least the following production techniques: the additive manufacturing, the part extraction, the surface treatment, and the cleaning. The surface treatment is preferred for modifying the surface by way of removing the oxide layer from the medical device the medical device, the medical device part, the medical device accessory, the medical device preform (herein, collectively the “article”) fabricated via additive manufacturing without destroying the article. The surface treatment is also preferable for (i) removing the unwanted parts from the article, (ii) creating smooth and even surface of the article, (iii) modifying parts of the article, and (iv) marking and engraving the article. All these capabilities are performed without destroying the article.

Optionally, an embodiment may comprise at least five of the production modules independently configured to perform at least the following production techniques: the additive manufacturing, the part extraction, the surface treatment, the cleaning, and the thermal or chemical treatment. This optional embodiment is particularly advantageous for manufacture of a medical device of which customized performance and treatment property is benefitted from thermal or chemical treatment.

Optionally, an embodiment may comprise at least six of the production modules independently configured to perform at least the following production techniques: the additive manufacturing, the part extraction, the surface treatment, the cleaning, the thermal or chemical treatment, and the surface finishing. This optional embodiment is particularly advantageous for manufacture of a medical device of which customized performance and treatment property is benefitted from surface smoothness, roughness, or tackiness.

Optionally, an embodiment may comprise at least seven of the production modules independently configured to perform at least the following production techniques: the additive manufacturing, the part extraction, the surface treatment, the cleaning, the thermal or chemical treatment, the surface finishing, and the quality control. This optional embodiment is particularly advantageous for manufacture of a medical device of which customized performance and treatment property is benefitted from surface smoothness, roughness, or tackiness, and special accuracy and quality control for high-precision medical devices.

Optionally, an embodiment may comprise at least eight of the production modules independently configured to perform at least the following production techniques: the additive manufacturing, the part extraction, the surface treatment, the cleaning, the thermal or chemical treatment, the surface finishing, the quality control, and the sterilization. This optional embodiment is particularly advantageous for manufacture of a medical device of which customized performance and treatment property is benefitted from surface smoothness, roughness, or tackiness, special accuracy and quality control, and disinfection for ready-to-use in operation of surgical theaters.

Optionally, an embodiment may comprise at least nine of the production modules independently configured to perform at least the following production techniques: the additive manufacturing, the part extraction, the surface treatment, the cleaning, the thermal or chemical treatment, the surface finishing, the quality control, the sterilization, and the labeling or packing. This optional embodiment is particularly advantageous for manufacture of a medical device of which customized performance and treatment property is benefitted from surface smoothness, roughness, or tackiness, special accuracy and quality control, disinfection and detailed identification during use.

The concept of the present invention is not limited to the physical location where the controlling software is hosted. Optionally, the controlling software may be hosted within the space occupied by an embodiment, or substantially adjacent thereto. Also optionally, the controlling software may be hosted remotely from the apparatus, and is connectable thereto via an information network, thereby upon the connection performing the administration of the operations of the at least two production modules, the integrating element, and the at least two inspection gates. The controlling software may be divided into multiple parts or multiple software modules which are hosted in separate physical locations.

Preferably, the controlling software is further configured to administer: collection of operating data, monitoring of operating status, detection of operating failure, data storage analysis, decision-making in the operation, and/or transmission of data to or from an external computer device which may be located nearby or remotely by any means of online communication methods.

Also preferably, the controlling software is further configured to administer at least one of the at least two production modules in performing a pre-production action before the medical device, the medical device part, the medical device accessory, or the medical device preform, is moved into the said at least one of the at least two production modules.

Also preferably, the controlling software is further configured to cause at least one of the at least two production modules to change one or more process parameter applicable to the said at least one of the at least two production modules.

Preferably, an embodiment comprises a single container to encase all the production at least two modules, the integrating element, and the at least two inspection gates. In an embodiment wherein the controlling software is also hosted, the said container should also encase a computer device or a computer-readable storage medium having the controlling software loaded thereon. More preferably, such an embodiment is further adapted to operate as a cleanroom.

In a further optional embodiment, the embodiment comprises a single container to encase all the at least two production modules, the integrating element, and the at least two inspection gates (and the storage medium or computer device upon which the controlling software is loaded, if applicable), and the internal space of the said container comprises further a compartment that is adapted to operate as a cleanroom, thereby providing an embodiment divided effectively into the cleanroom and non-cleanroom spaces. In such a further optional embodiment, it is preferable that the said compartment encases at least one of the at least two production modules independently configured to perform at least one of the production techniques independently selectable from the second group and the third group, effectively confining such at least one of the at least two production modules within the cleanroom space. The said groups of production techniques are previously enumerated above with respect to the configuration of the production modules.

In a yet further optional embodiment, the embodiment comprises a single container to encase all the at least two production modules, the integrating element, and the at least two inspection gates (and the storage medium or computer device upon which the controlling software is loaded, if applicable), said embodiment being further adapted to connect to another apparatus according to an embodiment having the single encasing container. In other words, two or more apparatuses according to this embodiment may be adapted to be interconnected.

An embodiment may be further adapted to be even more space efficient. Optionally, two or more of the at least two production modules are positioned substantially vertically to each other. And preferably, an embodiment may be fitted or adapted to any available area of a clinical facility. It is to be noted that the concept of the present invention encompasses a clinical facility having an apparatus according to an embodiment as well.

In the second aspect, an embodiment is a process for manufacturing a medical device, carried out entirely at a clinical facility. The said process comprises: a) based on a digitized drawing and a manufacturing instruction, processing the medical device, a medical device part, a medical device accessory, a medical device preform, or a raw material, using a production technique performed by a production module; b) moving, between two of the production modules, the medical device, the medical device part, the medical device accessory, or the medical device preform, obtained from step a) using an integrating element; and c) inspecting, outside the production module, the medical device, the medical device part, the medical device accessory, or the medical device preform obtained from step a) for dimension accuracy, surface roughness, cleanliness, and/or biological safety, using an inspection gate. Step a) is carried out at least twice using at least two different production techniques, one of such production techniques being additive manufacturing. Each of step b) and c) is carried out at least once.

Preferably, the said embodiment is administered by a controlling software. Optionally, the said controlling software is hosted remotely from the clinical facility.

In an optional embodiment, step a) is carried out at least four times, using at least four different production techniques in the following sequence: additive manufacturing, part extraction, surface treatment, and cleaning; and step c) is carried out at least four times in the following order: intervening the additive manufacturing and the part extraction; intervening the part extraction and the surface treatment; intervening the surface treatment and the cleaning; and after the cleaning.

In an optional embodiment, step a) is carried out at least five times, using at least five different production techniques in the following order: additive manufacturing, part extraction, thermal or chemical treatment, surface treatment, and cleaning; and step c) is carried out at least five times in the following order: intervening the additive manufacturing and the part extraction; intervening the part extraction and the thermal or chemical treatment; intervening the thermal or chemical treatment and the surface treatment; intervening the surface treatment and the cleaning; and after the cleaning. This optional embodiment is particularly advantageous for manufacture of a medical device of which customized performance and treatment property is benefitted from thermal or chemical treatment.

In an optional embodiment, step a) is carried out at least six times, using at least six different production techniques in the following order: additive manufacturing, part extraction, thermal or chemical treatment, surface treatment, surface finishing, and cleaning; and step c) is carried out at least six times in the following order: intervening the additive manufacturing and the part extraction; intervening the part extraction and the thermal or chemical treatment; intervening the thermal or chemical treatment and the surface treatment; intervening the surface treatment and the surface finishing; intervening the surface finishing and the cleaning; and after the cleaning. This optional embodiment is particularly advantageous for manufacture of a medical device of which customized performance and treatment property is benefitted from surface smoothness, roughness, or tackiness.

In an optional embodiment, step a) is carried out at least seven times, using at least seven different production techniques in the following order: additive manufacturing, part extraction, thermal or chemical treatment, surface treatment, surface finishing, cleaning, and quality control; and step c) is carried out at least seven times in the following order: intervening the additive manufacturing and the part extraction; intervening the part extraction and the thermal or chemical treatment; intervening the thermal or chemical treatment and the surface treatment; intervening the surface treatment and the surface finishing; intervening the surface finishing and the cleaning; intervening the cleaning and the quality control; and after the quality control. This optional embodiment is particularly advantageous for manufacture of a medical device of which customized performance and treatment property is benefitted from surface smoothness, roughness, or tackiness, and special accuracy and quality control for high-precision medical devices.

In an optional embodiment, step a) is carried out at least eight times, using at least eight different production techniques in the following order: additive manufacturing, part extraction, thermal or chemical treatment, surface treatment, surface finishing, cleaning, quality control, and sterilization; and step c) is carried out at least eight times in the following order: intervening the additive manufacturing and the part extraction; intervening the part extraction and the thermal or chemical treatment; intervening the thermal or chemical treatment and the surface treatment; intervening the surface treatment and the surface finishing; intervening the surface finishing and the cleaning; intervening the cleaning and the quality control; intervening the quality control and the sterilization; and after the sterilization. This optional embodiment is particularly advantageous for manufacture of a medical device of which customized performance and treatment property is benefitted from surface smoothness, roughness, or tackiness, special accuracy and quality control, and disinfection for ready-to-use in operation of surgical theaters.

In an optional embodiment, step a) is carried out at least nine times, using at least nine different production techniques in the following order: additive manufacturing, part extraction, thermal or chemical treatment, surface treatment, surface finishing, cleaning, quality control, sterilization, and labeling or packing; and step c) is carried out at least nine times in the following order: intervening the additive manufacturing and the part extraction; intervening the part extraction and the thermal or chemical treatment; intervening the thermal or chemical treatment and the surface treatment; intervening the surface treatment and the surface finishing; intervening the surface finishing and the cleaning; intervening the cleaning and the quality control; intervening the quality control and the sterilization; intervening the sterilization and the labeling or packing; and after the labeling or packing. This optional embodiment is particularly advantageous for manufacture of a medical device of which customized performance and treatment property is benefitted from surface smoothness, roughness, or tackiness, special accuracy and quality control, disinfection and detailed identification during use.

It should be clarified further that the inspection gate that is part of an apparatus according to the first aspect and that is used to perform step c) according the second aspect may be configured and placed within the apparatus/process so that a single inspection gate therein may perform the inspection many times at different stages of the process. In other words, in an exemplary process wherein step a) is carried out at least nine times and step c) is carried out at least nine times, that process may (and preferably, for space efficiency) require fewer than nine inspection gates to perform the said at least nine times of step c). This concept will become more apparent in the detailed description.

It is to be noted that the concept of the present invention encompasses a non-transitory computer-readable storage medium having the controlling software according to an embodiment loaded thereon, as well as a computer device or a computer processor having the controlling software according to an embodiment running thereon. The inspection gate (IG) inspects the device, part, or preform carried by the integrating element to conform to the applicable requirements and standards, including ISO 13485.

In addition to the above-specified limitations in some embodiments, there is no further limitation to the positioning or number of production modules (PMs), inspection gates (IGs), integrating elements (IEs), or controlling software (CS), in an embodiment. It is still within the concept of the present invention if between two PMs modules there are two IEs or two IGs, or between four PMs the exchange of information goes through a single CS.

An embodiment can be adapted to manufacture a wide range of medical devices, though the medical devices of which manufactures are particularly benefitted from the embodiment are those of which customization impacts the treatment outcomes. Notable examples of those medical devices include medical implants, surgical guides, pre-operative surgical models, and other invasive medical devices. The high level of customization enabled by the embodiments may be as well enjoyed by the manufacture of educational models, and prototypes of surgical devices or other medical devices.

The connectivity required to run the embodiment (i.e., between all the production modules) may be provided at a single physical location. The transportation of an embodiment may be carried out by a conventional means, including a truck and a freight container, or a specialized transport such as robotic wheels.

In an embodiment, each of the integrating elements (IE) is operated in a manual mode, a semi-automatic mode, or a fully automatic mode. Particularly, the IE may be a human or machine that handles and transfers the fabricated article from one production module to another. The manual transfer is performed by a person with or without using a forklift, remote control, trolley or similar moveable vehicle. The semi-automatic transfer is performed by a person cooperating with a stationary system that is operated on a routine command or a pre-programmed task, or with a belt conveyor system, a wheel conveyor system, a rail conveyor system, or an overhead crane system. The automatic transfer is carried out by a routine command, a pre-programmed task, or a real-time decision task without any human intervention, including a robotic arm, a movable robot, a computer vision guided system, and a mechanic transporting system.

The integrating element (IE) is selected according to requirements of the two production modules between which that IE is sequenced. For example, in an embodiment where an IE is sequenced between an additive manufacturing module and a part extraction module, that IE is preferably a movable vehicle on a transferring line. For another example, in an embodiment where an IE is sequenced between a thermal or chemical treatment module and a surface treatment module, that IE is preferably a mechatronic transporting system. For yet another example, in an embodiment where an IE is sequenced between a surface treatment module to a cleaning module, that IE is preferably a robotic arm.

In an embodiment, the inspection gate (IG) is used for inspecting and maintaining the required dimension accuracy, surface roughness, cleanliness, biological safety, or a combination thereof, of an article. The IG may be sequenced between any two production modules, which means the intended inspection and maintenance of the foregoing properties may be carried out every time that the article leaves from one production module to another. The inspection gate carries out an inspection technique that is appropriate for the inspection parameters required to determine an inspection subject of interest. For example, in an embodiment wherein the inspection subject is dimension accuracy (size, geometry, clearance, physical characteristic etc.), the inspection technique is independently selectable from the group comprising: caliper measuring, coordinate measuring, image detecting, image processing, 3D scanning, laser measuring, and pin gauge measuring. For another example, in an embodiment wherein the inspection subject is surface roughness (surface characteristic, appearance, porous characteristic, etc.), the inspection technique is independently selectable from the group comprising: 2D profiling, 3D profiling, laser profiling, atomic force microscope measuring, ultra-high-resolution imaging, blacklight imaging, ultraviolet imaging, 3D imaging, and electron microscopy imaging. For another example, in an embodiment wherein inspection subject cleanliness, the inspection technique is independently selectable from the group comprising: ultra-high-resolution imaging, blacklight imaging, ultraviolet imaging, electron microscopy imaging, total organic carbon testing, solution-based testing, atomic absorption spectroscopy (AAS), atomic emission spectroscopy (AES), atomic fluorescence spectroscopy (AFS), alpha particle x-ray spectroscopy (APXS), chromatography, differential scanning calorimetry (DSC), electron microscopy, energy dispersive spectroscopy (EDS/EDX), flow analysis, Fourier transform infrared spectroscopy (FTIR), gas chromatography (GC), high-performance liquid chromatography (HPLC), inductively coupled plasma (ICP), infrared spectroscopy (IR), laser induced breakdown spectroscopy (LIBS), mass spectroscopy (MS), optical microscopy, particle size analyzer (PSD), Raman spectroscopy, thermogravimetric analysis (TGA), X-ray photoelectron spectroscopy (XPS), X-ray diffraction (XRD), X-ray fluorescence spectroscopy (XRF), X-ray microscopy (XRM) and differential thermal analysis (DTA). For yet another example, in an embodiment wherein the inspection subject is biological safety, the inspection technique is independently selectable from the group comprising: cytotoxicity testing, hemolysis testing, limulus amoebocyte lysate bacterial endotoxin testing, bioburden testing, sterility testing and genetic toxicity testing.

In an embodiment, the additive manufacturing is used to fabricate an article from a layer-by-layer manufacturing technique that is independently selectable from a group consisting of laser-based printing, droplet-based printing, extrusion-based printing, powder bed fusion (PBF), direct metal laser sintering (DMLS), electron beam melting (EBM), selective heat sintering (SHS), selective laser sintering (SLS), direct metal laser melting (DMLM), binder jetting, material jetting, fused deposition modeling (FDM), fused filament fabrication (FFF), stereolithography (SLA), digital light processing (DLP), ink-based printing, laser-assisted printing, and direct energy deposition (DED). Optimizing processing parameters of those manufacturing techniques, an embodiment is capable of fabricating a medical device of a material independently selectable from the group comprising: metallic materials, polymer materials, ceramic materials, composite materials, biomaterials, or soft-tissue materials.

In an embodiment, the part extraction is used to separate an article from a printing platform or from a printing support. The part extraction technique is independently selectable from a group consisting of sawing, cutting, machining, grinding, vibration, etching, computer numerical control (CNC), laser-based extraction, chemical-based extraction, electro-chemical-based extraction, melting-based extraction, and dissolve-based extraction. Preferably, the part extraction technique is selected for its ability to reduce defect and deformation of the article being extracted/separated.

In an embodiment, the surface treatment is used to modify the surface or small area of an article. The surface treatment technique is independently selectable from a group consisting of blasting, polishing, grinding, vibration, tumbling, etching, CNC, laser-based treatment, chemical-based treatment, and electro-chemical-based treatment. The surface treatment technique can modify the following surface characteristics: roughness, fineness, and finishing. These surface characteristics may affect the medical device's performance, such as bone integration if that medical device is a bone implant.

In an embodiment, the cleaning is used to clean an article. The cleaning technique is independently selectable from a group consisting of solution-based cleaning, chemical-based cleaning, electrochemical-based cleaning, air-based cleaning, washing, rinsing, ultrasonic washing, ultrasonic cleaning, vibration, air blowing, air steaming, UV cleaning, chemical etching, oil cleaning, acid cleaning, dissolving, and media blasting. The cleaning's targets include particles, residues and debris deposited upon the article's surface which may introduce contamination that is particularly harmful for an invasive medical device. As such, the cleaning technique is preferably selected for its ability to decontaminate by way of physical or chemical cleaning, or light of specific wavelengths.

In an embodiment, the thermal or chemical treatment is used to modify or enhance material properties of an article. The thermal or chemical treatment technique is independently selectable from a group consisting of heating, annealing, sintering, conduction heating, convection heating, radiation heating, vacuum heating, laser heating, rapid heating, cyclic heating, laser curing, UV curing, light curing, homogenizing, chemical curing, gas curing, and cyclic chemical curing. The thermal or chemical treatment technique is preferably selected for its ability to transform the article's microstructure or the bonding between atoms and/or chain of molecules that would improve the article's physical properties in the way that benefits the intended performance of the medical device. The properties could be accordingly modified or enhanced for the entire article, for the specific part of the article, or at the surface of the article.

In an embodiment, the surface finishing is used to modify surface characteristic of the article. The surface finishing technique is independently selectable from a group consisting of mechanical polishing, wet electropolishing, dry electropolishing, chemical polishing, fine polishing, two-body abrasion, three-body abrasion, vibration, tumbling, and CNC. Selection of the foregoing techniques enables the customization of surface finish, from rough to matt to glossy or even mirror-like reflective. It is also possible to impart different surface finishes upon a single article.

In an embodiment, the quality control is used to check the quality or characteristic of the article. The quality control technique is independently selectable from a group consisting of caliper measuring, coordinate measuring, image detecting, image processing, 3D scanning, laser measuring, 2D profiling, 3D profiling, pin gauge measuring, atomic force microscope measuring, ultra-high-resolution imaging, blacklight imaging, ultraviolet imaging, and electron microscopy imaging.

In an embodiment, the sterilization is used to sterilize the article. The sterilization technique is independently selectable from a group consisting of steam sterilization, low temperature sterilization, X-ray sterilization, dry heat sterilization, ethylene oxide sterilization, and radiation sterilization. Sterilization obviates the need to sterilize the article before the medical operation, thereby reducing the operation's lead time.

In an embodiment, the labelling or packing is used to label or seal the article in a receptacle. The labelling or packing technique is independently selectable from a group consisting of laser marking, laser engraving, label printing, label affixing, sealing, thermo-plastic forming, box folding, pouch sealing, box sealing, and pelleting. Any information may be printed on the label, including the article's name, type, and identification, instructions of use, client's identification, patient's identification, date of manufacture, the date of sterilization, etc.

In an embodiment, the controlling software (CS) is used to communicate, or signal, or receive and/or transfer a digital file between the modules in the system. In such an embodiment, the CS receives digital file input and notice/signal the status of each process. After the PM has completed a task, the CS will send the information in the digital file output, said output will become an input for the next PM.

In an embodiment, the CS is used to receive a digital file as a complete or partial medical device drawing file for additive manufacturing. The file could be transferred to the CS on-site, on-cloud, or a combination thereof. Said drawing file may be a complete or partial medical device drawing file for additive manufacturing that is not limited to model file, slicing file, data of medical device file, or requirement/specification file of the medical device. The drawing or medical device files contain the data of medical device, device shape, device information, its intended use, specification or specific properties, and related data of the medical device for fabrication and inspection process.

The articles being manufactured may be made of metallic materials, metal powder, polymer materials, polymer filaments, liquid resins, ceramic materials, composite materials, biomaterials, or soft-tissue materials.

In an embodiment, the medical device is an implantable device, or a surgical guide, or a pre-operative surgical model, or an educational model, or a surgical prototype, or a device prototype. More specifically, the medical device includes cranioplasty mesh, maxillofacial implant, orthopedic implant, dental implant, and patient-specific implant.

A “medical device preform” refers to an unfinished form of a medical device, medical device part, or medical device accessory, to be further processed, transformed or treated to attain its finished form. Notable examples of medical device preform include an acetabular cup before augmentation and a reconstruction plate before bending.

A “medical device part” refers to a component of a medical device which cannot function independently unless assembled with other medical device parts to form a complete, ready-for-use medical device. It is within the present invention's purview that a production module in an embodiment may fabricate or handle a medical device part, to be later assembled and form a complete medical device down the production pathway. Therefore, it is possible to use an embodiment to manufacture a complex medical device whose different parts are processed via different production pathways and are imparted with different properties. Notable examples of medical device parts include femoral stem, femoral head, and plastic liner-all parts of a femur bone implant.

A “medical device accessory” refers to a medical device whose utility is to support, complement or augment the functionality of another medical device. Although an accessory is considered a complete medical device, it is not to be used independently. Notable examples of a medical device accessory include a surgical guide, a positioning guide, a protection sleeve, and anatomical bone model.

The present invention may be embodied alternatively by a method. Examples of such embodiments are summarized as follows:

In an embodiment, a method of medical device manufacturing system at point of care comprises: a) receiving a medical device drawing file or a file containing manufacturing's instruction and information of the medical device by a controlling software; b) fabricating a medical device according to the said file in a) by an additive manufacturing module. The preferred process parameters are selected to fabricate the medical device; c) optionally inspecting the medical device obtained from b) by at least one of inspection gate; and transferring the said medical device to subsequent module by at least one of integrating element; d) modifying the said medical device obtained from c) by at least one of production modules and at least one of integrating elements and inspection gate between each production module; and e) delivering the said medical device obtained from d) at the point of care, whereby the inspection gate is used for inspecting dimension accuracy, or surface roughness, or cleanliness of the medical device.

In an embodiment that is a method of medical device manufacturing system, the said modification of the medical device comprises: a) extracting the said medical device by a part extraction module that is selected by received data of medical device from previous module; b) optionally inspecting the said medical device obtained from a) by at least one of inspection gate that measure and collect the data of the said medical device; and transferring the said medical device to subsequent module by at least one of integrating element; c) treating the said medical device obtained from b) by a surface treatment module by using the medical device data and the requirement specification of the medical device; d) optionally inspecting the said medical device obtained from c) by at least one of inspection gate; and transferring the medical device to subsequent module by at least one of integrating element; e) cleaning the said medical device obtained from d) by a cleaning module that is selected from the previous process impurity and material of the said medical device; f) optionally inspecting the said medical device obtained from e) by at least one of inspection gate; and g) transferring the said medical device obtained from f) to a delivery station by at least one of integrating element.

In an embodiment that is a method of medical device manufacturing system, the said modification of the medical device comprises: a) extracting the said medical device by a part extraction module; b) optionally inspecting the said medical device obtained from a) by at least one of inspection gate; and transferring the medical device to subsequent module by at least one of integrating element; c) enhancing or treating the said medical device obtained from b) by a thermal or chemical module; d) optionally inspecting the said medical device obtained from c) by at least one of inspection gate; and transferring the medical device to subsequent module by at least one of integrating element; e) treating the said medical device obtained from d) by a surface treatment module; f) optionally inspecting the said medical device obtained from e) by at least one of inspection gate; and transferring the medical device to subsequent module by at least one of integrating element; g) cleaning the said medical device obtained from f) by a cleaning module; h) optionally inspecting the said medical device obtained from g) by at least one of inspection gate; and i) transferring the said medical device obtained from h) to a delivery station by at least one of integrating element.

In an embodiment that is a method of medical device manufacturing system, the said modification of the medical device comprises: a) extracting the said medical device by a part extraction module; b) optionally inspecting the said medical device obtained from a) by at least one of inspection gate; and transferring the medical device to subsequent module by at least one of integrating element; c) enhancing or treating the said medical device obtained from b) by a thermal or chemical module; d) optionally inspecting the said medical device obtained from c) by at least one of inspection gate; and transferring the medical device to subsequent module by at least one of integrating element; e) treating the said medical device obtained from d) by a surface treatment module; f) optionally inspecting the said medical device obtained from e) by at least one of inspection gate; and transferring the medical device to subsequent module by at least one of integrating element; g) modifying or engineering surface of the said medical device obtained from f) by a surface finishing module; h) optionally inspecting the said medical device obtained from g) by at least one of inspection gate; and transferring the said medical device to subsequent module by at least one of integrating element; i) cleaning the said medical device obtained from h) by a cleaning module; j) optionally inspecting the said medical device obtained from i) by at least one of inspection gate; and k) transferring the said medical device obtained from j) to a delivery station by at least one of integrating element.

In an embodiment that is a method of medical device manufacturing system, the said modification of the medical device comprises: a) extracting the said medical device by a part extraction module; b) optionally inspecting the said medical device obtained from a) by at least one of inspection gate; and transferring the said medical device to subsequent module by at least one of integrating element; c) enhancing or treating the said medical device obtained from b) by a thermal or chemical module; d) optionally inspecting the said medical device obtained from c) by at least one of inspection gate; and transferring the medical device to subsequent module by at least one of integrating element; e) treating the said medical device obtained from d) by a surface treatment module; f) optionally inspecting the said medical device obtained from e) by at least one of inspection gate; and transferring the said medical device to subsequent module by at least one of integrating element; g) modifying or engineering surface of the said medical device obtained from f) by a surface finishing module; h) optionally inspecting the said medical device obtained from g) by at least one of inspection gate; and transferring the said medical device to subsequent module by at least one of integrating element; i) cleaning the said medical device obtained from h) by a cleaning module; j) optionally inspecting the said medical device obtained from i) by at least one of inspection gate; and transferring the said medical device to subsequent module by at least one of integrating element; k) quality checking the said medical device obtained from j) by a quality control module; l) optionally inspecting the said medical device obtained from k) by at least one of inspection gate; and m) transferring the said medical device obtained from l) to a delivery station by at least one of integrating element.

In an embodiment that is a method of medical device manufacturing system, the said modification of the medical device comprises: a) extracting the said medical device by a part extraction module; b) optionally inspecting the said medical device obtained from a) by at least one of inspection gate; and transferring the said medical device to subsequent module by at least one of integrating element; c) enhancing or treating the said medical device obtained from b) by a thermal or chemical module; d) optionally inspecting the said medical device obtained from c) by at least one of inspection gate; and transferring the medical device to subsequent module by at least one of integrating element; e) treating the said medical device obtained from d) by a surface treatment module; f) optionally inspecting the said medical device obtained from e) by at least one of inspection gate; and transferring the said medical device to subsequent module by at least one of integrating element; g) modifying or engineering surface of the said medical device obtained from f) by a surface finishing module; h) optionally inspecting the said medical device obtained from g) by at least one of inspection gate; and transferring the said medical device to subsequent module by at least one of integrating element; i) cleaning the said medical device obtained from h) by a cleaning module; j) optionally inspecting the said medical device obtained from i) by at least one of inspection gate; and transferring the said medical device to subsequent module by at least one of integrating element; k) quality checking the said medical device obtained from j) by a quality control module; l) optionally inspecting the said medical device obtained from k) by at least one of inspection gate; and transferring the said medical device to subsequent module by at least one of integrating element; m) sterilizing the said medical obtained from l) device by a sterilization module; m) optionally inspecting the said medical device obtained from n) by at least one of inspection gate; and o) transferring the said medical device obtained from n) to a delivery station by at least one of integrating element.

In an embodiment that is a method of medical device manufacturing system, the said modification of the medical device comprises: a) extracting the said medical device by a part extraction module; b) optionally inspecting the said medical device obtained from a) by at least one of inspection gate; and transferring the said medical device to subsequent module by at least one of integrating element; c) enhancing or treating the said medical device obtained from b) by a thermal or chemical module; d) optionally inspecting the said medical device obtained from c) by at least one of inspection gate; and transferring the said medical device to subsequent module by at least one of integrating element; e) treating the said medical device obtained from d) by a surface treatment module; f) optionally inspecting the said medical device obtained from e) by at least one of inspection gate; and transferring the said medical device to subsequent module by at least one of integrating element; g) modifying or engineering surface of the said medical device obtained from f) by a surface finishing module; h) optionally inspecting the said medical device obtained from g) by at least one of inspection gate; and transferring the said medical device to subsequent module by at least one of integrating element; i) cleaning the said medical device obtained from h) by a cleaning module; j) optionally inspecting the said medical device obtained from i) by at least one of inspection gate; and transferring the said medical device to subsequent module by at least one of integrating element; k) quality checking the said medical device obtained from j) by a quality control module; l) optionally inspecting the said medical device obtained from k) by at least one of inspection gate; and transferring the said medical device to subsequent module by at least one of integrating element; m) sterilizing the said medical device obtained from l) by a sterilization module; n) optionally inspecting the said medical device obtained from m) by at least one of inspection gate; and transferring the said medical device to subsequent module by at least one of integrating element; o) labelling or packing the said medical device obtained from n) by a labelling or packing module; p) optionally inspecting the said medical device obtained from o) by at least one of inspection gate; and q) transferring the said medical device obtained from p) to a delivery station by at least one of integrating element.

### BRIEF DESCRIPTION OF DRAWINGS

The principle of the present invention and its advantages will become apparent in the following description, taking into consideration the accompanying drawings in which:

FIG. 1 shows a conceptual block diagram of the first exemplary embodiment of an apparatus for manufacturing a medical device that is implemented to carry out the first exemplary embodiment of a process for manufacturing a medical device at a clinical facility.

FIG. 2 shows a conceptual block diagram of the second exemplary embodiment of an apparatus for manufacturing a medical device that is implemented to carry out the second exemplary embodiment of a process for manufacturing a medical device at a clinical facility.

FIG. 3 shows a conceptual block diagram of the third exemplary embodiment of an apparatus for manufacturing a medical device that is implemented to carry out the third exemplary embodiment of a process for manufacturing a medical device at a clinical facility.

FIG. 4 shows a schematic diagram of an exemplary embodiment of an apparatus having Layout 1 (not to scale).

FIG. 5 shows a schematic diagram of an exemplary embodiment of an apparatus having Layout 2 (not to scale).

FIG. 6 shows a schematic diagram of an exemplary embodiment of an apparatus having Layout 3 (not to scale).

FIG. 7 shows a schematic diagram of an exemplary embodiment of an apparatus having Layout 4 (not to scale).

FIG. 8 shows a schematic diagram of an exemplary embodiment of an apparatus having Layout 5 (not to scale).

FIG. 9 shows a schematic diagram of an exemplary embodiment suitable for manufacturing a cutting guide model (not to scale).

FIG. 10 shows a schematic diagram of an exemplary embodiment suitable for manufacturing a titanium orthopedic implant (not to scale).

FIG. 11 shows a schematic diagram of an alternative embodiment suitable for manufacturing a titanium orthopedic implant (not to scale).

FIG. 12 shows a schematic diagram of two connected exemplary embodiments suitable for manufacturing a broad range of articles (not to scale).

FIG. 13 shows a schematic diagram of two connected alternative embodiments suitable for manufacturing a broad range of articles (not to scale).

FIG. 14 shows a side-view schematic diagram of an exemplary embodiment that is vertically integrated (not to scale).

FIG. 15 shows a simplified cutaway drawing of a truck carrying an apparatus according to an exemplary embodiment (not to scale).

FIG. 16 shows an overall flowchart of a process according to an exemplary embodiment.

FIG. 17 shows a focused flowchart of a system initialization step, according to an exemplary embodiment.

FIG. 18 shows a focused flowchart of an article identification and planning step, according to an exemplary embodiment.

FIG. 19 shows a focused flowchart of production module assignment step, according to an exemplary embodiment.

FIG. 20 shows a focused flowchart of a production module running step, according to an exemplary embodiment.

FIG. 21 shows a conceptual block diagram of an exemplary embodiment comprising four production modules and the process pathways in view of the inspection's decision loops.

FIG. 22 shows a conceptual block diagram of an exemplary embodiment comprising nine production modules and the process pathways in view of the inspection's decision loops.

FIG. 23 shows a simplified cutaway drawing of an apparatus designed for use within a clinical facility or point of care according to an exemplary embodiment (not to scale).

### DETAILED DESCRIPTION OF EXEMPLARY EMBODIMENTS

It is to be understood that the following detailed description will be directed to embodiments, provided as examples for illustrating the concept of the present invention only. The present invention is in fact not limited to particular embodiments described, as such may, of course, vary. It is also to be understood that the terminology used herein is for the purpose of describing particular embodiments only, and is not intended to be limiting, since the scope of this invention will be limited only by the appended claims.

The detailed description of the invention is divided into various sections only for the reader's convenience and disclosure found in any section may be combined with that in another section.

Unless defined otherwise, all technical and scientific terms used herein have the same meaning as commonly understood by one of ordinary skills in the art to which this invention belongs.

It must be noted that as used herein and in the appended claims, the singular forms “a”, “an”, and “the” include plural referents unless the context clearly dictates otherwise.

“Comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a device or method consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

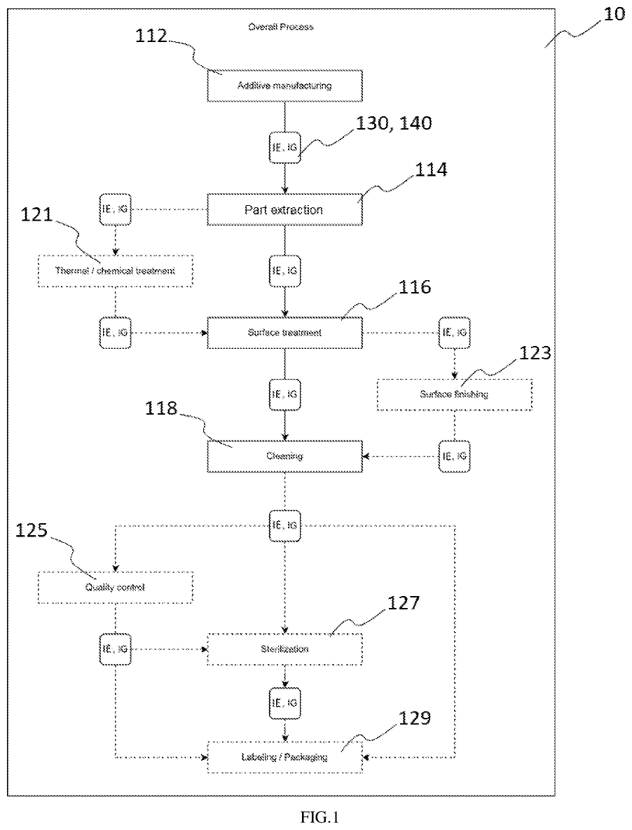

FIG. 1 shows a conceptual block diagram of the first exemplary embodiment of an apparatus for manufacturing a medical device that is implemented to carry out the first exemplary embodiment of a process for manufacturing a medical device entirely at a clinical facility. In this specification, the “clinical facility” refers to a place where medical treatment may be administered or provided to a patient, including a hospital, medical clinic, nursing center, and any establishment having an infirmary, medical examination room, a patient ward or a similar facility that is considered a point of care (e.g., a school or sports center). The embodiment's technical characteristics make it most advantageous to be placed/implemented at or near the point of care, though such consideration does not limit the scope of the present invention. The medical device manufacturing apparatus 10 comprises several production modules. In this embodiment, the production modules include those considered “main” modules and “supplementary” modules. The “main modules”, represented in FIG. 1 as blocks drawn in solid lines, are an additive manufacturing module 112, a part extraction module 114, a surface treatment module 116, and a cleaning module 118. The “supplementary modules”, represented in FIG. 1 as blocks drawn in broken lines, are a thermal/chemical treatment module 121, a surface finishing module 123, a quality control module 125, a sterilization module 127, and a labeling/packing module 129.

In this exemplary embodiment, the “main” production modules form the core process pathway implemented by the apparatus 10. Those main production modules are sequenced from the additive manufacturing module 112, the part extraction module 114, the surface treatment module 116, and then to the cleaning module 118. The core pathway is represented in FIG. 1 as solid line arrows. It is to be reiterated that under the concept of the present invention, it is not required that all the four main production modules in this exemplary embodiment must be present. As previously set forth in the Summary, an embodiment according to the present invention may comprise at least two production modules.

In this exemplary embodiment, the “supplementary” production modules form the optional process pathway implemented by apparatus 10. #Those supplementary production modules are ordered from the thermal/chemical treatment module 121 (preferably sequenced after the part extraction module 114 and before the surface treatment module 116), the surface finishing module 123 (preferably sequenced after the surface treatment module 116 and before the cleaning module 118), the quality control module 125 and the sterilization module 127 (preferably sequenced after the cleaning module 118), and then to the labeling/packing module 129 (preferably sequenced after the quality control module 125 and after the sterilization module 127). The optional pathway is represented in FIG. 1 as broken line arrows.

An integrating element (IE) 130 and an inspection gate (IG) 140 are sequenced between any two production modules of adjacent orders, regardless of the nature of those modules (i.e., notwithstanding being main or supplementary production modules).

In this exemplary embodiment, any manufacture of a medical device is bound to follow the core process pathway carried out by all its four constituent main production modules 112, 114, 116, 118. On the other hand, the optional process pathway and each its supplementary production modules 121, 123, 125, 127, 129 may or may not be involved in the manufacture. In other words, in this exemplary embodiment, all the main production modules 112, 114, 116, 118 are mandatory for the manufacture of all medical devices; each the supplementary production modules 121, 123, 125, 127, 129 may be relevant to the manufacture of some medical devices.

Further, the arrangement of the production modules was investigated in several trials.

The first trial was conducted under the following exemplary constraints: four main production modules 112, 114, 116, 118 were used; the additive manufacturing module 112 was always the first production module by which the embodiment was run. Thus, from the remaining three main production modules 114, 116, 118 arose 6 possible sequences. From these possible sequences, the inventors determined that the following sequence was most preferred: starting from the additive manufacturing module 112, then the part extraction module 114, and then the surface treatment module 116, and finally the cleaning module 118.

The second trial was conducted under the following exemplary constraints: the four main production modules 112, 114, 116, 118 were used and arranged according to the most preferred sequence as determined from the first trial; five supplementary production modules 121, 123, 125, 127, 129 were added to the embodiment. A number of preferred sequences were determined based on the medical device file, design specification, and type of medical device application.

The production modules, IG, IE are modular elements which may be configured and reconfigured to perform any technique or independent of specific band. For example, the additive manufacturing module 112 which in one embodiment uses the direct metal laser melting technique may be reconfigured in another embodiment to use the electron beam melting technique instead. Not only the production modules, but also the IG, IE, or controlling software may be reconfigured, upgraded, updated, or augmented with an add-on option to satisfy circumstantial requirements. Each embodiment will be installed on/in a connector platform that is designed to carry the weight of all the production module, integrating elements, and inspection gates. Applicable connector platforms that are not limited to a platform on the floor, container, or anything else that can contain the electric system, network system, gas system, water system, etc. The connector platform connects the machine that is selected for each modules/elements/gate and also connects to another connector platform. This flexible configuration is enabled by the embodiment's modular nature, whereby the elements can be flexibly upgraded, updated or add-on option. #

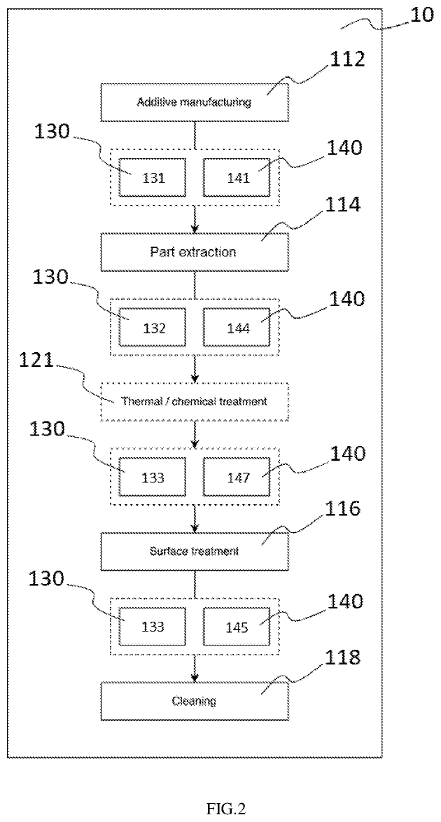

FIG. 2 shows a conceptual block diagram of the second exemplary embodiment of an apparatus for manufacturing a medical device that is implemented to carry out the second exemplary embodiment of a process for manufacturing a medical device entirely at a clinical facility. Here, the medical device manufacturing apparatus 10 comprises the main modules of the previous exemplary embodiment: the additive manufacturing module 112, the part extraction module 114, the surface treatment module 116, and the cleaning module 118. The apparatus 10 further comprises the thermal/chemical treatment module 121, a supplementary production module, that is sequenced after the part extraction module 114 and the surface treatment module 116.

The embodiment shown in FIG. 2 comprises the integrating elements (IE, 130) that are configured into a manual integration mode 131, a semi-automatic integration mode 132, and a fully automatic integration mode 133. More particularly, the integrating element 130 that is sequenced after the additive manufacturing module 112 and before the part extraction module 114 is configured into the manual integration mode 131; the integrating element 130 that is sequenced after the part extraction module 114 and before the chemical/thermal treatment module 121 is configured into the semi-automatic integration mode 132; the integrating element 130 that is sequenced after the chemical/thermal treatment module 121 and before the surface treatment module 116 is configured into the fully automatic integration mode 133; and finally, the integrating element 130 that is sequenced after the surface treatment module 116 and before the cleaning module 118 is configured into the fully automatic integration mode 133.

In this exemplary embodiment, the inspection gate (IG) 140 may be configured into seven inspection modes based upon the combination of the inspection subjects. In this embodiment, the inspection subjects are (1) dimension accuracy, (2) surface roughness, and (3) cleanliness and (4) biological safety. As such, the first inspection mode 141 is configured to cover the subject of dimension accuracy alone; the second inspection mode 142 is configured to cover the subject of surface roughness alone; the third inspection mode 143 is configured to cover the subject of cleanliness alone; the fourth inspection mode 144 is configured to cover the subject of dimension accuracy and cleanliness; the fifth inspection mode 145 is configured to cover the subject of surface roughness and cleanliness; the sixth inspection mode 146 is configured to cover the subject of dimension accuracy and surface roughness; and finally, the seventh inspection mode 147 is configured to cover the subject of dimension accuracy, surface roughness, and cleanliness.

The embodiment shown in FIG. 2 comprises the inspection gates (IG) 140 that are configured differently. More particularly, the inspection gate 140 that is sequenced after the additive manufacturing module 112 and before the part extraction module 114 is configured into the first inspection mode 141; the inspection gate 140 that is sequenced after the part extraction module 114 and before the chemical/thermal treatment module 121 is configured into the fourth inspection mode 144; the inspection gate 140 that is sequenced after the chemical/thermal treatment module 121 and before the surface treatment module 116 is configured into the seventh inspection mode 147; and finally, the inspection gate 140 that is sequenced after the surface treatment module 116 and before the cleaning module 118 is configured into the fifth inspection mode 145.

FIG. 2 exemplifies the technical advantage of the embodiment's modular nature. The connection between any two production modules may be configured very flexibly such that any circumstantial requirements may be satisfied. Such configuration is administered through the controlling software (CS) component of the embodiment.

The controlling software can receive the digital data from cloud server network/or other systems that are connected to an embodiment. The controlling software will send said data to the production module and monitor the production module's status. When a process component has been carried out by the respective production module, a signal will be sent to the controlling software for controlling the preparation of the next production module in the sequence. For example, the integrating elements will be ready to bring the said fabricated medical device, and the inspection gate will receive the controlling software's instructions to prepare for measuring the medical device and collecting the results, which then will be sent to the controlling software, from which the data will be analyzed and forwarded to the next production modules further in the sequence.

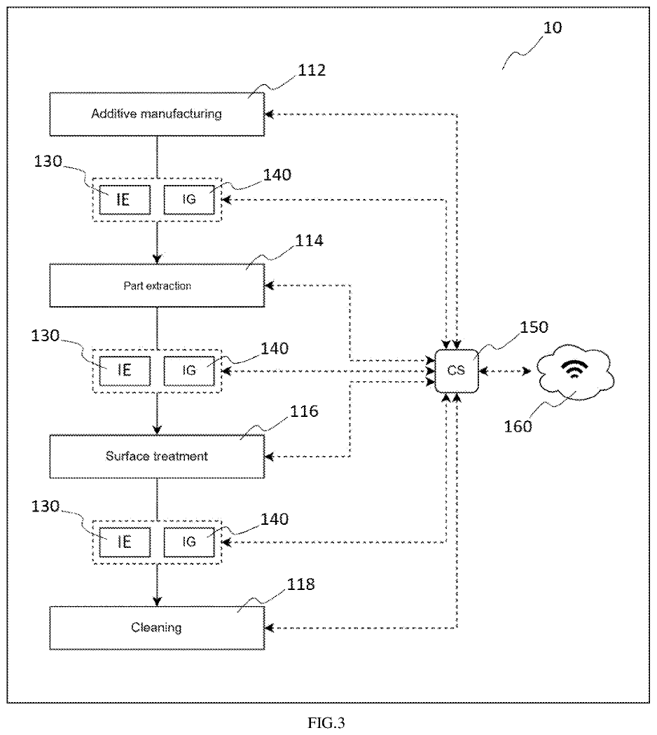

FIG. 3 shows a conceptual block diagram of the third exemplary embodiment of an apparatus for manufacturing a medical device that is implemented to carry out the third exemplary embodiment of a process for manufacturing a medical device at a clinical facility. This embodiment comprises all the main production modules 112, 114, 116, 118. As with previous embodiments, the integrating elements (IE) 130 and the inspection gates (IG) 140 are sequenced between two production modules. Further, a controlling software (CS) 150 is electronically interconnected to all the production modules 112, 114, 116, 118 and to all the integrating elements 130 and the inspection gates 140. In this embodiment, the controlling software 150 is further connected to an information network 160, which may be the Internet or an intranet via a wired or wireless connection. The information network 160 may be further connected to a server, cloud, or storage.

In the embodiment shown in FIG. 3, the controlling software 150 administers the synergy among the production modules 112, 114, 116, 118, the integrating elements 130 and the inspection gates 140. For example, the controlling software 150 receives via the information network 160 instructions to run the manufacture. Then the controlling software 150 transmits the instructions to the additive manufacturing module 112 to perform the additive manufacturing technique which corresponds to the additive manufacturing module's 112 current configuration and process parameters that are transmitted along with the instructions. After the additive manufacture is near complete, the additive manufacturing module 112 transmits a signal to the controlling software 150 to prepare for the transfer of article to the next production module. Upon receiving that signal, the controlling software 150 sends instructions to the integrating element 130, the inspection gate 140, and the part extraction module 114. Then the integrating element 130 prepares the integration according to the integration mode that has been configured for that integrating element 130. For example, in an embodiment where the integration mode is automatic conveyor belt, then the instruction from the controlling software 150 causes the integration element 130 to activate the conveyor belt and check if it can be run normally. In the meantime, the inspection gate 140 then prepares the inspection according to the inspection mode that has been configured for that inspection gate 140. For example, if that inspection gate 140 is configured to perform the first inspection mode 141, then the dimension accuracy check is prepared. Also in the meantime, the part extraction module 114 then prepares the tools and conditions (e.g., heat, etc.) which are necessary to perform the extraction. In the event that the inspection gate 140 detects a defective article leaving from the additive manufacturing module 112, then the inspection gate transmits a signal to the controlling software 150 which according to its predetermined decision loop, may transmit response instructions to the inspection gate 140 in order to reject the article and/or transmit further instructions to halt the operation of the entire embodiment. The controlling software 150 administers similar procedures in connection with the rest of the production modules 114, 116, 118 and the rest of the integration elements 130 and inspection gates 140 which are sequenced between said production modules 114, 116, 118.

As will be shown in FIGS. 4-8, embodiments may be arranged in any way to meet the space requirements at the site of implementation. Depictions in FIGS. 4-8 are non-limiting and not exhaustive and should be viewed as illustrative examples. This flexibility is enabled by the embodiments' modular nature.

FIG. 4 shows a schematic diagram of an exemplary embodiment of an apparatus having Layout 1. This layout comprises the production modules, integrating elements, and inspection gates arranged in the horizontal direction (I-line).

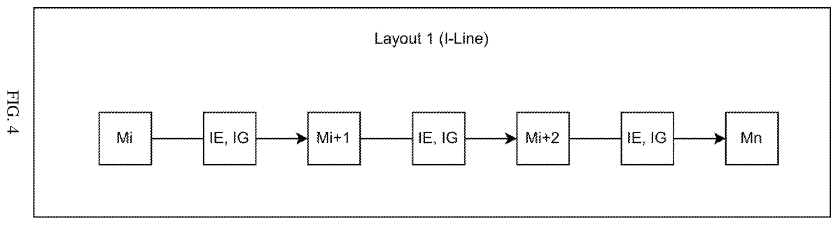

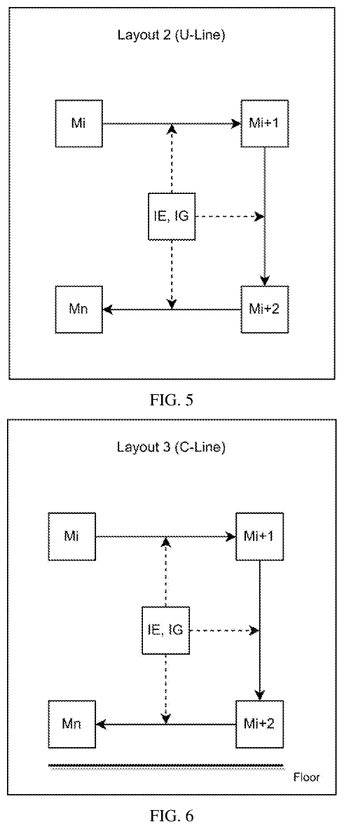

FIG. 5 shows a schematic diagram of an exemplary embodiment of an apparatus having Layout 2. This layout comprises the production modules, integrating elements, and inspection gates arranged in the U-shape direction, the said integrating elements and the inspection gates could be placed between each production module and/or in the center of the process pathway.

FIG. 6 shows a schematic diagram of an exemplary embodiment of an apparatus having Layout 3. This layout comprises the production modules, integrating elements, and inspection gates arranged in the C-shape direction in the vertical direction. The said integrating elements and the inspection gates could be placed between each production module and/or in the center of the process pathway.

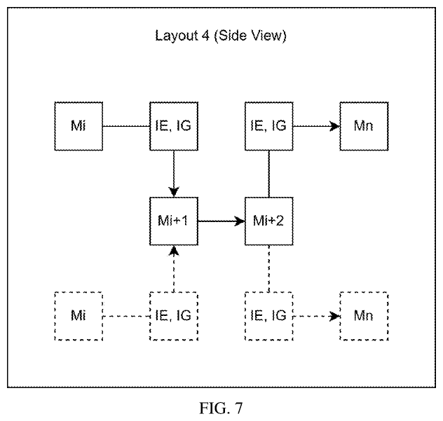

FIG. 7 shows a schematic diagram of an exemplary embodiment of an apparatus having Layout 4. Layout 4 comprises the production modules, integrating elements, and inspection gates that has one or more inputs and/or one or more outputs.

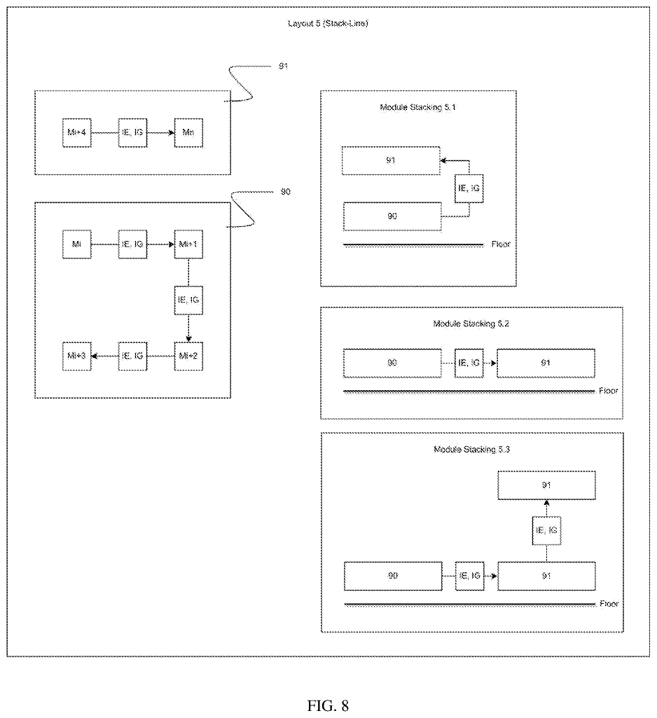

FIG. 8 shows a schematic diagram of an exemplary embodiment of an apparatus having Layout 5. Layout 5 comprises the stacking of the connection set of the production modules, integrating elements, and inspection gate, stacking in the horizontal and/or vertical direction.

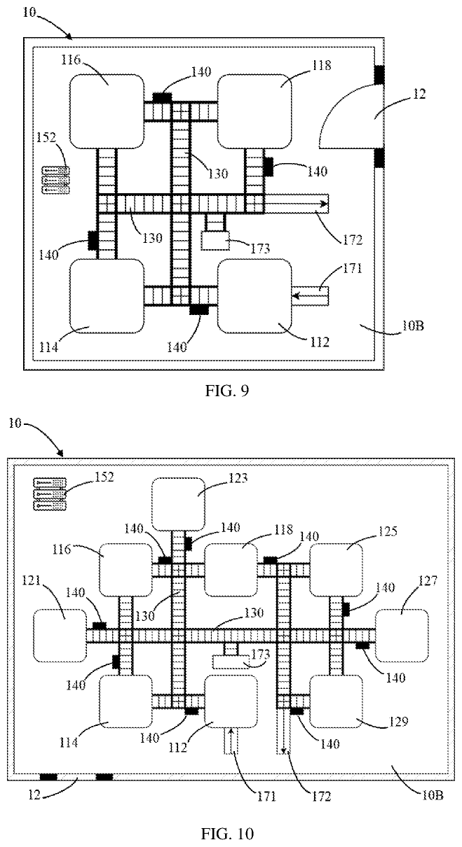

FIG. 9 shows a schematic diagram of an exemplary embodiment suitable for manufacturing a cutting guide model. Here, the apparatus 10 implements a fully automated manufacturing process. The apparatus 10 comprises a single container encasing the additive manufacturing module 112, the part extraction module 114, the surface treatment module 116, and the cleaning module 118, the said additive manufacturing module 112 succeeding the inlet 171 and the said cleaning module 118 preceding the outlet 172. In this embodiment, the inlet 171 introduces the raw material of the cutting guide model to the additive manufacturing module 112, and the finished cutting guide model leaves the apparatus through the outlet 172. The apparatus 10 also comprises the integrating elements 130 which are conveyor belts interconnecting the said production modules 112, 114, 116, 118, and four inspection gates 140 placed along the integrating elements 130 so as (i) to intervene the additive manufacturing module 112 and the part extraction module 114, (ii) to intervene the part extraction module 114 and the surface treatment module 116, (iii) to intervene the surface treatment module 116 and the cleaning module 118, and (iv) to follow the cleaning module 118. The apparatus 10 further comprises the computer device 152, comprising the non-transitory computer-readable storage medium, onto which the controlling software is loaded. The apparatus 10, accessible through the door 12, confines a cleanroom space 10B within which the production modules 112, 114, 116, 118, the integrating elements 130, the inspection gates 140, the computer device 152, and a scrap receptacle 173 are positioned. The cleanroom space's 10B cleanroom conditions may be achieved according to the known arts.

FIG. 10 shows a schematic diagram of an exemplary embodiment suitable for manufacturing a titanium orthopedic implant. Here, the apparatus 10 implements a fully automated manufacturing process. The apparatus 10 comprises a single container encasing the additive manufacturing module 112, the part extraction module 114, the surface treatment module 116, the cleaning module 118, the thermal/chemical treatment module 121, the surface finishing module 123, the quality control module 125, the sterilization module 127, and the labeling/packing module 129, the said additive manufacturing module 112 succeeding the inlet 171 and the said labeling/packing module 129 preceding the outlet 172. In this embodiment, the inlet 171 introduces the raw material of the implant (e.g., titanium alloy powder) to the additive manufacturing module 112, and the finished orthopedic implant leaves the apparatus through the outlet 172. The apparatus 10 also comprises the integrating elements 130 which are conveyor belts interconnecting the said production modules 112, 114, 116, 118, 121, 123, 125, 127, 129, and nine inspection gates 140 placed along the integrating elements 130 so as (i) to intervene the additive manufacturing module 112 and the part extraction module 114, (ii) to intervene the part extraction module 114 and the surface treatment module 116, (iii) to intervene the surface treatment module 116 and the cleaning module 118, (iv) to intervene the cleaning module 118 and the thermal/chemical treatment module 121, (v) to intervene the thermal/chemical treatment module 121 and the surface finishing module 123, (vi) to intervene the surface finishing module 123 and the quality control module 125, (vii) to intervene the quality control module 125 and the sterilization module 127, (viii) to intervene the sterilization module 127 and the labeling/packing module 129, and (ix) to follow the labeling/packing module 129. The apparatus 10 further comprises the computer device 152, comprising the non-transitory computer-readable storage medium, onto which the controlling software is loaded. The apparatus 10, accessible through the door 12, confines a cleanroom space 10B within which the production modules 112, 114, 116, 118, 121, 123, 125, 127, 129, the integrating elements 130, the inspection gates 140, the computer device 152, and a scrap receptacle 173 are positioned. The cleanroom space's 10B cleanroom conditions may be achieved according to the known arts.

FIG. 11 shows a schematic diagram of an alternative embodiment suitable for manufacturing a titanium orthopedic implant. This embodiment shares many features with the embodiment previously described relative to FIG. 10, and thus discussion on their similarities will be omitted for brevity of the present Detailed Description. As distinct from FIG. 10, the alternative embodiment shown in FIG. 11 comprises a single container which is further divided by a compartment wall 16 into a non-cleanroom space 10A and a cleanroom space 10B. The non-cleanroom space 10A encases the additive manufacturing module 112, the part extraction module 114, the surface treatment module 116, the cleaning module 118, the thermal/chemical treatment module 121, and the surface finishing module 123. The cleanroom space 10B encases the quality control module 125, the sterilization module 127, and the labeling/packing module 129. Traversals between the compartment which operates as the non-cleanroom space 10A and the compartment which operates as the cleanroom space 10B may be made through an airlock room 14 or a pass-box 18, the former being configured for a personnel's access and the latter for an article's access, both operating in a similar manner. Each of the airlock room 14 and the pass-box 18 comprises at least two airtight hatches separated by an airlock space, at least one of said hatches adjoining the non-cleanroom space 10A and at least the other one adjoining the cleanroom space 10B. The airlock room 14 and the pass-box 18 are configured such that any hatch(es) adjoining the non-cleanroom space 10A can be unsealed only if all the hatch(es) adjoining the cleanroom space 10B is sealed, and vice versa. The sealing/unsealing of the hatches of the airlock room 14 and the pass-box 18 may be administered manually or automatically. In this embodiment, however, the sealing/unsealing of the hatches of the pass-boxes 18 is favorably administered automatically by the controlling software, to synchronize the article's cross-compartment traversal with the operations of the production modules 112, 114, 116, 118, 121, 123, 125, 127, 129, the integrating elements 130, and the inspection gates 140. In this way, the waiting time and consumption of resources to maintain the cleanroom conditions are substantially optimized.

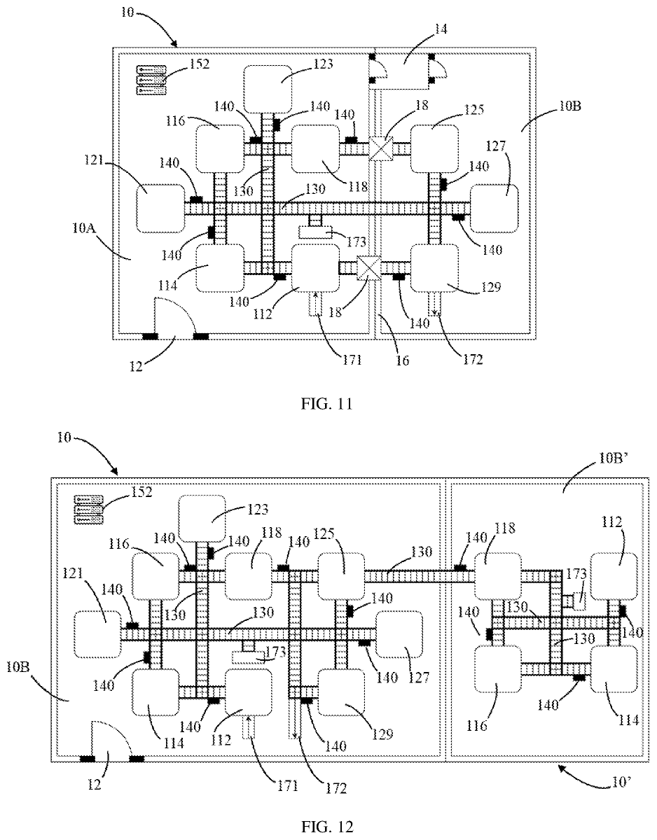

FIG. 12 shows a schematic diagram of two connected exemplary embodiments suitable for manufacturing a broad range of articles. Here, the first apparatus 10 is connected to the second apparatus 10′. The connection allows the article exiting the cleaning module 118 of the second apparatus 10′ to pass into the first apparatus 10 along the process pathway that is formed by the integrating element 130 running through the walls of the two apparatuses 10, 10′; yet the same connection is airtight so that both the apparatuses 10, 10′ can maintain the cleanroom conditions in their respective cleanroom spaces 10B, 10B′. The components and configurations of the first apparatus 10 are substantially similar to the embodiment depicted in FIG. 10 above; thus, for brevity, the description relative to FIG. 10 shall apply to the first apparatus 10 of FIG. 12. The components and configurations of the second apparatus 10′ are substantially similar to the embodiment depicted in FIG. 9 above; thus, for brevity, the description relative to FIG. 9 shall apply to the second apparatus 10′ of FIG. 12. The connection between apparatuses 10, 10′ forms a multi-apparatus medical device manufacturing system, conferring synergism in both production capacity and scheduling efficiency.

Consider the system according to FIG. 12 in the manufacture of an orthopedic implant and a surgical guide. In a likely embodiment that the manufacture of the surgical guide requires four “main” production modules 112, 114, 116, 118 which are encased in the second apparatus 10′, the surgical guide is more efficiently manufactured by the second apparatus 10′. While it is also possible to configure the controlling software so that the surgical guide is manufactured by the first apparatus 10, skipping some of the “supplementary” production modules 121, 123 and optionally processed by some of the “supplementary” production modules 125, 127, 129, but skipping modules is inefficient: It incurs lag time and the loss of opportunity that the production modules being skipped 121, 123 may be employed instead in the manufacture of an orthopedic implant.

Therefore, the system according to FIG. 12 enables the manufacture of both the orthopedic implant and the surgical guide simultaneously. The surgical guide is moved from the second apparatus 10′ into the first apparatus 10, where the surgical guide and the orthopedic implant share the process pathway through the quality control module 125, the sterilization module 127, and the labeling/packing module 129. This advantageous pathway-sharing is enabled by the surgical guide being manufactured more quickly than the implant (as the former requires no processing of some production modules 121, 123) and by the administration of the controlling software.

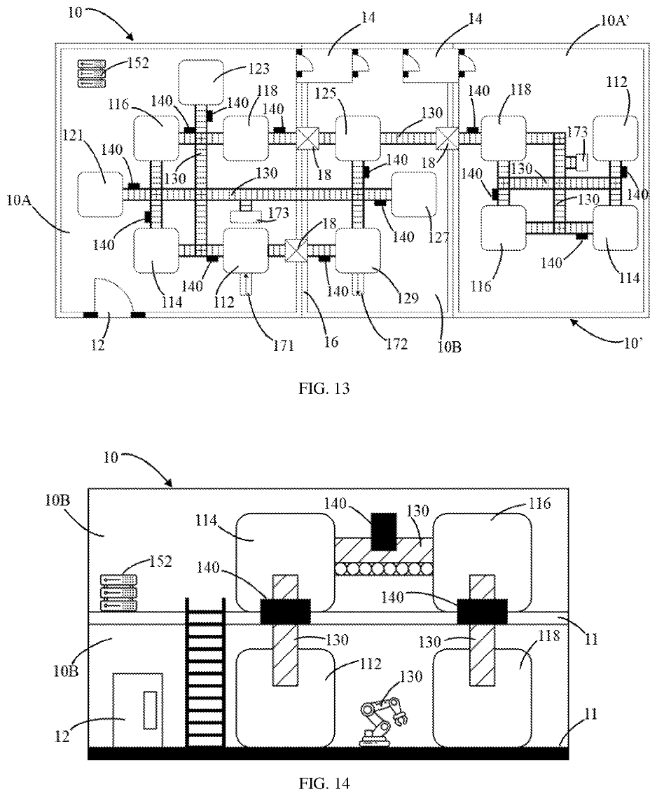

FIG. 13 shows a schematic diagram of two connected alternative embodiments suitable for manufacturing a broad range of articles. Here, the first apparatus 10 is connected to the second apparatus 10′. The components and configurations of the first apparatus 10 are substantially similar to the embodiment depicted in FIG. 11 above; thus, for brevity, the description relative to FIG. 11 shall apply to the first apparatus 10 of FIG. 13. The components and configurations of the second apparatus 10′ are substantially similar to the embodiment depicted in FIG. 9 above; thus, for brevity, the description relative to FIG. 9 shall apply to the second apparatus 10′ of FIG. 13. The connection between apparatuses 10, 10′ forms a multi-apparatus medical device manufacturing system, conferring synergism in both production capacity and scheduling efficiency that is similar to the connection as depicted in FIG. 12 and described previously.

A notable difference between FIG. 13 and FIG. 12 is the arrangement of cleanroom space. In FIG. 13, the first apparatus 10 is divided by a compartment wall 16 into a non-cleanroom space 10A and a cleanroom space 10B. Similarly to FIG. 11, the non-cleanroom space 10A encases the additive manufacturing module 112, the part extraction module 114, the surface treatment module 116, and the cleaning module 118, the thermal/chemical treatment module 121, and the surface finishing module 123; the cleanroom space 10B encases the quality control module 125, the sterilization module 127, and the labeling/packing module 129. On the other hand, the second apparatus 10′ encases the additive manufacturing module 112, the part extraction module 114, the surface treatment module 116, and the cleaning module 118, in a non-cleanroom space 10A′.

In the process pathway joined according to FIG. 13, an article may pass between the non-cleanroom and cleanroom spaces 10A, 10B within the first apparatus 10, or between the first apparatus's 10 cleanroom space 10B and the second apparatus's 10′ non-cleanroom space 10A′, through the pass-boxes 18. Personnel may pass between the foregoing spaces 10A, 10B within same apparatus and between the foregoing apparatuses 10, 10′ through airlock rooms 14. Descriptions of the pass-boxes 18 and the airlock rooms 14 have been previously provided relative to FIG. 11. This arrangement of cleanroom space is advantageous in confining the cleanroom conditions to some of the production modules 125, 127, 129 for whose operations the cleanroom conditions are essential. The other production modules 112, 114, 116, 118, 121, 123 are placed within the non-cleanroom spaces 10A, 10A′, thereby providing more personnel accessibility and consuming less energy to maintain the cleanroom conditions.

In all the embodiments according to FIGS. 9-13, the inspection gates 140, being placed along the integrating elements 130 at the described positions with respect to production modules 112, 114, 116, 118, 121, 123, 125, 127, 129 are check-points deployed to detect any defects which may be present in the work-in-progress article. Such detection takes place immediately after the article has left the production module in which the defects first occur. The inspection gate 140 is connected to the controlling software which in turn administers the operation of all the production modules 112, 114, 116, 118, 121, 123, 125, 127, 129 and the integrating elements 130. With this, the inspection gate 140 is configured to send a signal to the controlling software hosted on the computer device 152. The said signal carries the computer-executed decision to Pass, Rework or Reject (for more details, see About Inspection Gates (IGs), further below).

Following the receipt of the Pass decision, the controlling software sends (i) a signal to the integrating element 130 connected to that inspection gate 140 to move the article forward to the succeeding production module and (ii) a signal to that succeeding production module to prepare for the next step of production.

Following the receipt of the Rework decision, the controlling software sends (i) a signal to the integrating element 130 connected to that inspection gate 140 to move the article back to the preceding production module and (ii) a signal to that preceding production module to prepare for the correction of defects.

Following the Reject decision, the controlling software sends (i) a signal to the integrating elements 130 which form a path from that inspection gate 140 to the scrap receptacle 173, to direct the defective article towards the scrap receptacle 173 where the article is disposed, and (ii) a signal to the preceding production module to prepare for the repeated production.

In predetermined circumstances, for example, one in which a similar type of defect has occurred repeatedly, the controlling software is configured to send the signal according to (ii) which also carry the instructions to adjust the process parameters in response to such circumstances.

The above-described structural and operational synergy between the production modules, the integrating elements, the inspection gates, and the controlling software enables early handling of defects and feedback loop. The defective article is either corrected or ejected from the production line before resources are wasted in carrying the article through the more downstream process steps, and the process parameters may be adjusted in real time to avoid the recurrence of defects with much reduced waiting time. Compared with a conventional medical device manufacturing apparatus or system whose quality control step is positioned towards the end of the process (one such prior art is U.S. Pat. No. 10,528,031 B2), the embodiments are substantially more advantageous.

FIG. 14 shows a side-view schematic diagram of an exemplary embodiment that is vertically integrated. Here, the apparatus 10 comprises the “main” production modules 112, 114, 116, 118. The additive manufacturing module 112 and the cleaning module 118 are disposed on the lower floor, supported by a connector platform 11; whereas the part extraction module 114 and the surface treatment module 116 are disposed on the upper floor, also supported by another connector platform 11. FIG. 14 shows further that the mode of integrating elements 130 may circumstantially vary in the same embodiment: The integrating element 130 forming the process pathways between the additive manufacturing module 112 and the part extraction module 114, and between the surface treatment module 116 and the cleaning module 118 are vertical/inclined conveyor belts; the integrating element 130 between the part extraction module 114 and the surface treatment module 116 is a horizontal conveyor belt; the integrating element 130 at the exit of cleaning module 118 is a robotic arm. FIG. 14 also shows that the inspection gates 140 may as well be located and operable along the process pathways leading upwards and downwards.

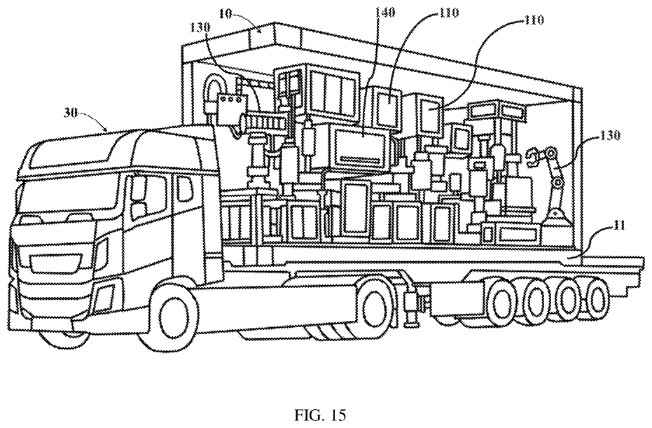

FIG. 15 shows a simplified cutaway drawing of a truck carrying an apparatus according to an exemplary embodiment. Here, the cutaway walls of the apparatus 10 reveals its contents comprising several production modules 110, integrating elements 130 and inspection gates 140, all disposed fixedly upon the connector platform 11 and interconnected in accordance with any of the previously described embodiments. FIG. 15 shows the apparatus 10 mounting on a truck 30, thereby depicting the advantage of an embodiment constructed as a ready-to-transport compact unit, which is also, more favorably, an embodiment comprising a single container (which, even more favorably, is a modified standard 20-feet or 40-feet intermodal container) to encase all the production modules 110, the integrating elements, 130 and the inspection gates 140. In this way, the apparatus 10 may be transported securely in its ready-to-operate conditions, with little need to disassemble at the place of origin and to re-assemble at the destination, save only for the power supply and information connectivity.

### About Production Modules (PMs)

As previously noted, the selection of production techniques to be carried out by PMs and included in an embodiment depend on many factors, including the first input entering the embodiment and the final output leaving the embodiment. The schedule in the next sheet shows specific examples of suitable selections based on the said factors. The check marks indicate the selection/inclusion in the embodiment.

| | | | | | | | thermal or | | | | |
|---|---|---|---|---|---|---|---|---|---|---|---|
| | | Example of | additive | part | surface | | chemical | surface | quality | | labeling or |
| First Input | Final Output | Final Output | manufacturing | extraction | treatment | cleaning | treatment | finishing | control | sterilization | packing |
| Raw | Medical | Metal | ✓ | ✓ | ✓ | ✓ | ✓ | ✓ | ✓ | ✓ | ✓ |
| materials | device | implant | | | | | | | | | |
| Raw | Medical | Surgical | ✓ | ✓ | — | ✓ | — | — | ✓ | ✓ | ✓ |
| materials | device | guide | | | | | | | | | |
| | accessory | | | | | | | | | | |
| Medical | Medical | Femoral | ✓ | — | ✓ | ✓ | ✓ | — | ✓ | — | ✓ |
| device | device | stem | | | | | | | | | |
| part | part | | | | | | | | | | |
| Medical | Medical | Patient- | ✓ | — | — | ✓ | — | — | ✓ | ✓ | ✓ |
| devices | device | specific | | | | | | | | | |
| preform | | implant | | | | | | | | | |
| Medical | Sterilized | Standard | — | — | — | — | — | — | ✓ | ✓ | ✓ |
| device | medical | implant | | | | | | | | | |
| | device | | | | | | | | | | |
| Raw | Non- | Metal | ✓ | ✓ | ✓ | ✓ | — | — | ✓ | — | — |
| materials | sterilized | implant | | | | | | | | | |
| | medical | | | | | | | | | | |
| | device | | | | | | | | | | |

### About Integrating Elements (IEs)

Examples of IEs include: 2200 Series belted conveyors, supplied by Dorner, the controller of which being modified to receive the signals from the controlling software, suitable as an IE for moving the article from the additive manufacturing production module to the part extraction module; Model RVC Vertical flow conveyors, supplied by Thomas Conveyor & Equipment Co., suitable as an IE for vertically moving the article from a thermal or chemical treatment module to a surface treatment module; GEN 3 LITE ROBOT, a robotic arm supplied by Kinova, suitable as an IE for moving the article from a surface treatment module to a cleaning module. The scope of applicable IE is not limited by its direction along which it moves the article. It is also within the present invention's purview to configure the IE to move the article in a horizontal, vertical, or inclined direction. It is also within the invention's purview to configure the IE to move the article to-and-fro between two production modules.

### About Inspection Gates (IGs)

Exemplary working steps of IGs. The following description is directed to the series of steps which an exemplary IG was configured to take. All the steps were administered by the controlling software (CS). It is to be noted that the scope of applicable IG is not limited by the below steps or by the order by which the exemplary IG carried out the steps.

First, the IG received the article from the preceding IE. Second, the IG ran an initial assessment of the article to determine the specific parameters to be inspected, including checking the device type, material, properties, and any customized specifications which may be provided from the product catalog, 3D model, CT-scan, MRI, or customer's requirements. Third, the IG set the inspection parameters, including temperature, pressure, dimensional accuracy, and surface finish, that were relevant to the type of medical device. Fourth, the IG performed the inspection using a combination of sensors, cameras, and other measurement tools. This fourth step further included visual inspection for surface defects, dimensional measurement using lasers or other non-contact methods, and functional tests to ensure the device operates as intended. Fifth, the IG collected and analyzed the data in real-time. The algorithm, which may be either loaded on the IG or be part of the CS, analyzed the data to identify any deviation from the quality standard or acceptance criteria. Sixth, the IG executed an action for the article, said action is selectable from Pass, Rework, and Reject. If the article met all quality criteria, then the IG executed a “Pass” to move that article forward to the next stage in the manufacturing process, which may be the next production module or the end of process; if the article did not meet the quality criteria and the defects were correctible, then the IG executed a “Rework” to move that article back to the production module which was suitable for correcting the defect; finally, if the article did not meet the quality criteria and the defects were uncorrectable or the rework was infeasible, then the IG executed a “Reject” to move that article out of the production pathway. Seventh, the IG sent the inspection results and data into the feedback loop to enable the CS to decide on the adjustment of process parameters for a PM based on the common defects/issues found from the inspection. Eighth, the IG prepared for the next inspection cycle by resetting its parameters and tools based on the next article in the manufacturing queue.

In an exemplary embodiment, the modification of a 3D scanner into an Inspection Gate (IG) for medical device production enhances its capabilities to capture detailed 3D images for precise device fabrication. This enhancement involves an initial assessment of its performance, software upgrades for better integration with the controlling software, and the development of software to analyze images against design standards. This process ensures that devices meet quality benchmarks and involves equipping the scanner with a flexible mounting system for optimal positioning, quick-swap fixtures for various device geometries, and automated adjustments to streamline preparation for scanning. Integrated seamlessly into the production line for both in-line and off-line scanning through robotic automation, the scanner's modifications are coordinated by a compact unit like a PLC or microcontroller, which communicates with the CS, transforming the scanner into a vital part of the manufacturing process to ensure product integrity and smooth workflow integration.

Exemplary selection of IG's inspection techniques. Preferred selection criteria are based on the production techniques performed by the production modules (PMs) positioned before and/or after the IG in the process pathway. The production techniques classified as the first group, the second group, and the third group (the member of each group being enumerated above in the Summary of Invention) correspond to the below exemplary selection criteria:

Between two PMs performing two production techniques of the first group, the IG favorably performs an inspection technique independently selectable from the group of: caliper measuring, coordinate measuring, image detecting, image processing, 3D scanning, laser measuring, and pin gauge measuring.

Between a PM performing a production technique of the first group and another PM performing a production technique of another group, the IG favorably performs an inspection technique independently selectable from the group of: 2D profiling, 3D profiling, laser profiling, atomic force microscope measuring, ultra-high-resolution imaging, blacklight imaging, ultraviolet imaging, 3D imaging, and electron microscopy imaging.

Between a PM performing a production technique of the second group and another PM performing a production technique of another group, the IG favorably performs an inspection technique independently selectable from the group of: ultra-high-resolution imaging, blacklight imaging, ultraviolet imaging, and electron microscopy imaging.

Between two PMs performing two production techniques of the third group, the IG favorably performs an inspection technique independently selectable from the group of: biological indicator testing, and chemical indicator testing.

Finally, after a PM performing a production technique of the third group and without the next PM (i.e., approaching the end of process pathway), the IG favorably performs an inspection technique independently selectable from the group of: image detecting, image processing, 3D scanning, and laser measuring. Specific examples of inspection techniques' placements will be discussed below.

In an exemplary embodiment, a PM performed the additive manufacturing technique, and then a subsequent PM performed the part extraction technique. Between the said two PMs was placed an IG to perform the coordinate measuring technique to inspect the coordinate points in comparison with the original model. The said IG was a coordinate measuring machine supplied by Mitutoyo.

In an exemplary embodiment, a PM performed the additive manufacturing technique, and then a subsequent PM performed the part extraction technique. Between the said two PMs was placed an IG to perform the coordinate measuring technique to inspect the coordinate points in comparison with the original model. The said IG was a coordinate measuring machine supplied by Mitutoyo.

In an exemplary embodiment, a PM performed the part extraction technique, and then a subsequent PM performed the thermal or chemical treatment technique. Between the said two PMs was placed an IG to perform the 3D scanning technique to inspect the coordinate points in comparison with the original model. The said IG was Atos Q, supplied by Zeiss.

In an exemplary embodiment, a PM performed the thermal or chemical treatment technique, and then a subsequent PM performed the surface treatment technique. Between the said two PMs was placed an IG to perform the image detecting technique to inspect the color on the article's surface. The said IG was Keyence VR 6000.

In an exemplary embodiment, a PM performed the surface treatment technique, and then a subsequent PM performed the surface finishing technique. Between the said two PMs was placed an IG to perform the laser measuring technique to inspect the article's surface roughness. The said IG was Laser sensor, Keyence.

In an exemplary embodiment, a PM performed the surface finishing technique, and then a subsequent PM performed the cleaning technique. Between the said two PMs was placed an IG to perform the 3D scanning technique to inspect the article's surface roughness. The said IG was Keyence LM series.

In an exemplary embodiment, a PM performed the cleaning technique, and then a subsequent PM performed the quality control technique. Between the said two PMs was placed an IG to perform the blacklight imaging technique to detect the spectrum difference of alien substance on the article's surface. The said IG was LAB01 BB 2.0 IKAROS Mains, TED.

In an exemplary embodiment, a PM performed the quality control technique, and then a subsequent PM performed the sterilization technique. Between the said two PMs was placed an IG to perform the ultra-high-resolution imaging technique to superimpose the images and compare the contours. The said IG was Keyence Ultra-high-resolution Model 64-megapixels camera.

In an exemplary embodiment, a PM performed the sterilization technique, and then a subsequent PM performed the labeling or packing technique. Between the said two PMs was placed an IG to perform the chemical indicator testing technique to detect chemical indicators with image detection. The said IG was Keyence Ultra-high-resolution Model 64-megapixels camera.

In an exemplary embodiment, a PM performed the labeling or packing technique, and then the process pathway approached the end. After the said PM was placed an IG to perform the image detecting and image processing techniques for image identification. The said IG was Keyence Ultra-high-resolution Model 64-megapixels camera.

### Computer Devices Suitable for Implementing the Controlling Software

Preferably, the controlling software (CS) is executed by a processor of a programmable logic controller (PLC). The present inventors found the PLC with the following minimum requirements particular suitable for the implementation of an embodiment: 1 GHz ARM Cortex™-A8 processor (TC3: 30); flash memory: 512 MB microSD card (exchangeable, expandable); 1 GB DDR3-RAM (internal, not expandable); 2×RJ45 Ethernet connection 10/100 Mbit/s (internal switch); 4×USB 2.0 interface; 1×DVI-D interface; 2×microSD card slot; 128 kB NOVRAM integrated; diagnostics LED: 1×power, 1×TC status, 2×flash access, 2×bus status; protection class: IP20. Suitable commercially available PLC models included Schneider Modicon PLC M580, Honeywell MasterLogic PLC, Siemens SIMATIC S7-1200, and Beckhoff CX5130.

Optionally, an embodiment may include displaying the data processed by the CS on a human machine interface (HMI) linked directly or indirectly to an embodiment. The present inventors found the following commercially available HMI models suitable: Schneider Harmony ST6, Honeywell 900 Control Station HMI, Siemens SIMATIC HMI Panels, and Beckhoff CP39xx, CP79xx

PLC and HMI may be part of an embodiment (on-site data connection) or not part of an embodiment (on-line or remote data connection) and may be linked to an embodiment in any number of units.

### About the Process and Administration by the Controlling Software

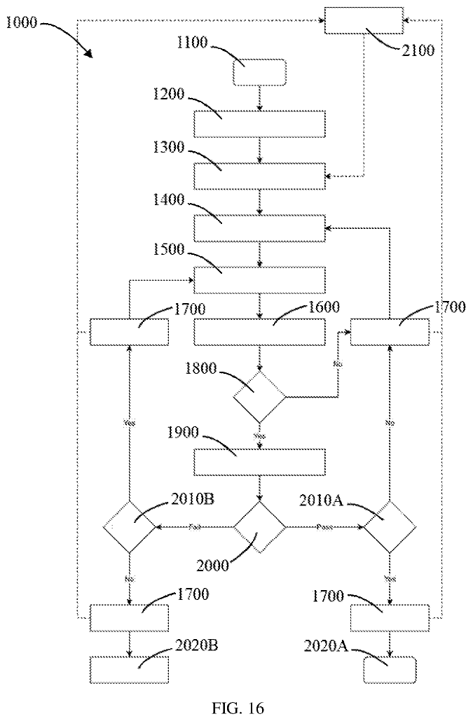

FIG. 16 shows an overall flowchart of a process according to an exemplary embodiment in which the administration of this process 1000 is carried out automatically by the controlling software (CS). The present flowchart covers one production cycle. Upon the start 1100, the system initialization 1200 step is run to prepare for operation and to initialize the necessary components for the production cycle.

The next step is the article identification and planning 1300, wherein the article (the medical device, medical device part, medical device preform, or medical device accessory, which is the object of this production cycle) is identified; and a corresponding detailed plan is crated based on the requirements applicable to the article. The said plan includes the production process steps through which the article must go, the materials, and the article's other special characteristics or specifications. Further references to the “production plan” mean the plan created thus in this step 1300.

Further is the step of production module assignment 1400, wherein the CS evaluates the production modules (PMs) available in the apparatus/system of apparatuses for their capabilities and statuses; then the CS assigns the steps required to complete the production plan to the most suitable PMs.

The process 1000 then proceeds to the step of integrating element assignment 1500, wherein the CS evaluates the integrating elements (IE) available in the apparatus/system of apparatuses to optimize the process pathway linking the PMs assigned according to the previous step 1400 and along which the article will move until the process completion. The CS will administer the operations of the assigned IEs to move the article along the branching pathways to be described in the following paragraphs.

This is followed by the step of running the production module 1600, wherein one of the PMs, assigned previously in step 1400, runs the production process upon the article; this step includes receiving the article's parameters, setting up the PM pursuant to the requirements (received previously in step 1300) and executing the said production process accordingly.

The process 1000 then moves on to the step of checking inspection requirements 1800, wherein the CS verifies, with reference to the production plan, whether the article exiting the PM activated in the previous step 1600 requires inspection by an inspection gate (IG). If there is such a requirement, then the process 1000 takes the route forward to the step of inspection gate assignment 1900; if not, then the process 1000 loops back through the data collection step 1700 and then to the step of PM assignment 1400 (the data collection step 1700 will be fully described later).

In the step of IG assignment 1900, the article is directed towards the IG positioned along the process pathway. In that IG, the step of running inspection gate 2000 is performed: The article is inspected for its quality and conformity with the previously determined specifications.

If the said quality and conformity is found in step 2000, then the CS receives the Pass signal from the immediate IG, and the process 1000 proceeds to the decision loop for passing the inspection 2010A, wherein the CS checks against the production plan whether the PM from which the immediate article had most recently exited was the final PM in the production plan. If that PM is the final PM, then the CS determines that the production plan has been completed; and the process 1000 progresses through the data collection step 1700 and then to the first mode of the step of process termination 2200: delivering the article 2200A. If, however, that PM is not the final PM, then the process 1000 loops back through the data collection step 1700 and then to the step of PM assignment 1400 to assign the succeeding PM for performing the next processing step upon the article. This loopback at this decision loop 2010A recurs until the PM is the final PM in the production plan, which triggers the data collection 1700 and delivery 2200A.

Alternatively, if the said quality and conformity is not found in step 2000 (i.e., the article is defective), then the process 1000 branches to the decision loop for failing the inspection 2010B, wherein the CS checks the signal received from the immediate IG whether the defect is not correctable (the Reject signal) or is correctable (the Rework signal). In the case of Reject signal, then the process 1000 progresses through the data collection step 1700 and then to the second mode of the step of process termination 2200: disposing the article 2200B, in which the article is disposed in the nearest scrap receptacle as previously shown and described in FIGS. 9-13. In the case of Rework signal, then the process 1000 loops back through the data collection step 1700 and then to the step of IE assignment 1500 to optimize the pathway along which the defective article will be returned to the defect-responsible PM (i.e., the PM from which the article had most recently exited) in which the defect correction will be attempted.

In this embodiment, the data collection step 1700 is sequenced in the loopback pathway after the step of checking inspection requirements 1800 as well as in all the process pathways following the decision loops for passing the inspection and for failing the inspection 2010A, 2010B. The data collected thus will be fed to the step of process optimization 2200 wherein the CS analyzes the data and dynamically updates the production plan in step 1300. The updated production plan will then be implemented during the production cycle and without shutting off the pending operation.

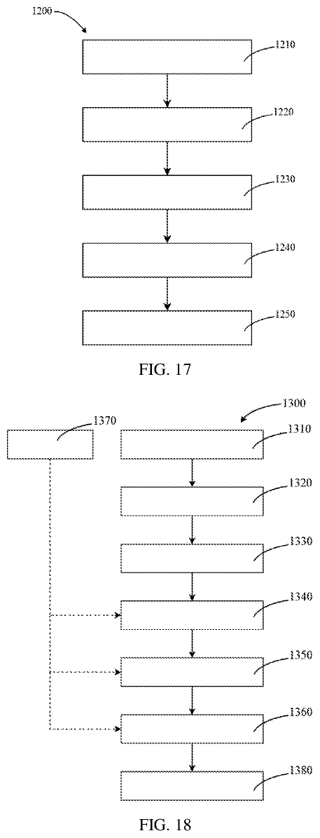

The following FIGS. 17-20 show focused flowcharts depicting further details of certain process components previously shown in FIG. 16.

FIG. 17 shows a focused flowchart of a system initialization step, according to an exemplary embodiment. Here, the system initialization step 1200 begins with checking system and detecting component 1210, followed by establishing communication protocols 1220, configuring the component 1230, synchronization 1240, and verifying operational readiness 1250, respectively.

In checking system and detecting component 1210, the CS checks and catalogues the PMs, IEs, and IGs (collectively the “components”) within the apparatus/system of apparatuses, along with the components' characteristics, statuses, and operational prerequisites or constraints that must be observed.

In establishing communication protocols 1220, the CS sets up uniform communication protocols to facilitate the data flow/exchanges/processing and synchronized actions of the components within the apparatus/system of apparatuses. This setting up includes configuring the network links, setting up addressing configurations, and standardizing the data formats.

In configuring the component 1230, the CS configures each of the PMs, IEs, and IGs in alignment with their capabilities and system requirements. The said configurations are calibrated against operational parameters, performance benchmarks, and quality criteria.

In synchronization 1240, the CS aligns the components within a common time schedule for their harmonized operations and activity logging. Synchronization 1240 is essential to the cohesive manufacturing process and effective monitoring/management.

In verifying operational readiness 1250, the CS assesses and confirms the functionality, status, configuration, and readiness of all the components in the production cycle. Its outputs, to be forwarded to the article identification and planning step 1300, is the system status report containing each component's operational conditions, issues found, and the apparatus/system of apparatuses' overall readiness to start the production.

FIG. 18 shows a focused flowchart of an article identification and planning step, according to an exemplary embodiment. Here, the article identification step 1300 begins with receiving article's specification 1310, followed by determining process steps 1320, checking capabilities of production module 1330, calculating the current operational efficiency 1340, optimizing time 1350, determining workflow sequence 1360, and generating production plan 1380. In this embodiment, analyzing historical data 1370 further informs the steps of calculating the current operational efficiency 1340, optimizing time 1350, determining workflow sequence 1360.

In receiving article's specification 1310, the CS receives the article's specification which contains the following data: raw material, dimensions, and patient/physician special requirements. Further, the CS receives the system status report from the system initialization step 1200 along with other data such as queue length, production time estimates, and scheduled maintenance.

In determining process steps 1320, checking capabilities of production module 1330, and calculating the current operational efficiency 1340, the CS processes the information received previously in 1310 to determine the process steps necessary to achieve the article's production, to evaluate each PM's capabilities, and to calculate the current operational efficiency to confirm the efficient handling of the article.

In optimizing time 1350, the CS employs an algorithmic approach, including the shortest path algorithms, queuing theory models, and machine-learning regression, to optimize the process pathways through the PMs required to achieve the article's production. In this embodiment, the CS also advantageously determines the alternative pathway(s) to be followed if the optimized pathway becomes not viable, including the event of congestion along the IEs.

In determining workflow sequence 1360, the CS bases its calculation upon the time optimized in the previous step 1350 to determine the sequence by which the components will be activated and run. The said activation covers the pre-running/transitory preparation of the components (see the below discussion relative to step 1440 for more detail on preparations).

In generating production plan 1380, the CS compiles the foregoing data and analysis to create the production plan which will govern the subsequent workings of all components respective to the production of the article.

In analyzing historical data 1370, the CS processes the historical performance data (partially collected in the data collection step 1700 shown previously in FIG. 17) and generates insight from the execution of past production plans for similar articles. In this embodiment, the repository for these historical data contains at least average production time, frequent bottlenecks, and adjustments or countermeasures which produced positive responses. In this embodiment, the said data are fed to some of the steps 1340, 1350, 1360 to inform and refine the eventual generation of the production plan.

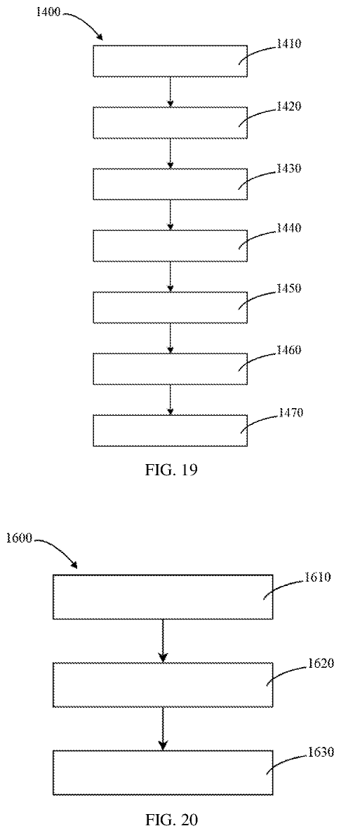

FIG. 19 shows a focused flowchart of production module assignment step, according to an exemplary embodiment. Here, the production module assignment step 1400 begins with receiving the production plan 1410, followed by analyzing the article's specifications 1420, dynamic selection of the production module 1430, preparing the production module 1440, configuring the route of integrating elements 1450, scheduling the inspection gate 1460, and balancing the loads and resolving conflicts 1470, respectively.

After receiving the production plan 1410 generated from the previous step 1300, the CS starts analyzing the article's specifications 1420 (see the above discussion on step 1310 for more details) to determine its manufacturing requirements. This involves identifying the materials and production processes the article must go through to attain the said specifications.

In dynamic selection of the production module 1430, the CS checks the immediate PM's operational statuses, capabilities and any restrictions potentially impacting its ability to impart the specifications upon the article. If applicable, the CS selects the PM from the pool of PM candidates and assigns the selected PM to perform the relevant production process steps. The selection is carried out dynamically, taking into consideration the PM's workload, efficiency, and location within the apparatus/system of apparatuses.

In preparing the production module 1440, the CS sends signals to the next-in-line PM dynamically selected in the previous step 1430, initiating that PM to prepare for the performance of production process. The preparation includes the boot-up, tool adjustments, pre-heating, and material-loading. In this embodiment, the PM is further configured to return a signal to the CS to confirm its readiness to perform.

In configuring the route of integrating elements 1450, the CS determines the optimal time-efficient pathway formed by IEs leading from the immediate PM to the next-in-line PM (based on the production plan). In scheduling the inspection gate 1460, the CS is run in a manner similar to the previous step 1450 but with respect to the immediate IG. The underlying object of these two steps 1450, 1460 is to minimize the waiting time and delays.

In balancing the loads and resolving conflicts 1470, the CS projects/tracks the article's movement and status (or several articles moving in the apparatus/system of apparatuses, as the case may be) to detect the potential overloads, bottlenecks and conflicts which may fault the production plan. Upon the finding of potential overloads, bottleneck or conflicts, the CS determines the countermeasure (e.g., rerouting an article or imposing a waiting time) and sends a signal to the relevant component(s) to implement the countermeasure and resolve the said adverse potential.

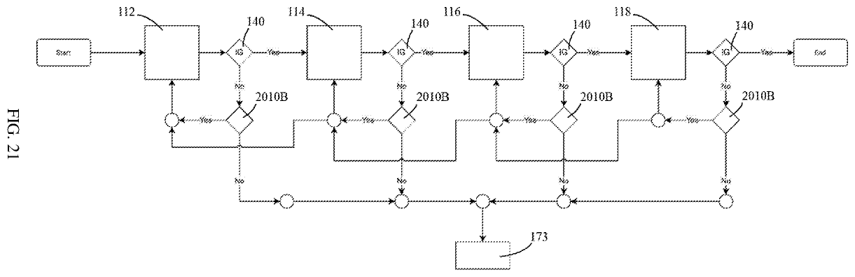

FIG. 20 shows a focused flowchart of a production module running step, according to an exemplary embodiment. Here, the production module running step 1600 begins with receiving the article's specifications 1610, followed by setting up the production module 1620, and running the production module 1630, respectively.

After the PM has received the article's specifications (see the above discussion on step 1310 for more details) from the CS, the step of receiving the article's specifications 1610 is completed. Then, setting up the production module 1620 includes the PM's booting up, configuring its tools, loading the relevant computer-readable instructions into the PM's processor (if applicable), and feeding materials and/or deploying its parts necessary for performing the assigned production step.

In running the production module 1630, the PM processes/transforms the article according to its assigned roles in the production plan and article specifications. The CS also monitors the PM's performance in real time to obtain data that may pertain to the quality and specification conformity. In this embodiment, the CS is further configured to implement real-time adjustments and optimizations of the PM in response to deviation, defects, or other issues that may be considered underperformance.

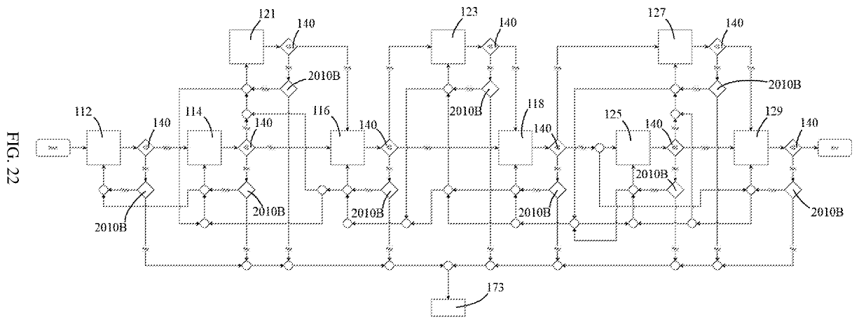

FIG. 21 shows a conceptual block diagram of an exemplary embodiment comprising four production modules and the process pathways in view of the inspection's decision loops. Here, the description will follow the movement of an article pending in the embodiment, as well as its transformation and redirection in the branching process pathways. Actions performed by the components shown in FIG. 21 are automatically administered by the controlling software (CS).

Following the start, the process parameters are set for, and the slicing digital file is imported to, the additive manufacturing module 112. The additive manufacturing module 112 transforms the raw material (metal alloy powders, ingots, resins, etc.) into an article according to the production plan. In the meantime, the CS collects the estimated time of completion which informs the timing of its signal to be sent to the next-in-line PM. Upon the additive manufacturing module's 112 task completion, the CS signals the immediate IE to move the article towards the immediate inspection gate (IG) which performs the coordinate measuring inspection technique upon the article. The CS then collects the geometry results arising from the IG's inspection and compares the geometry results with the 3D model and generates a Pass/Rework/Reject signal. The CS then signals the integrating elements (IEs) to (i) forward the Pass-article towards the part extraction module 114, or (ii) return the Rework-article to the additive manufacturing module 112, or (iii) redirect the Reject-article to the scrap receptacle 173.

Next, the process parameters are set for the part extraction module 114. The part extraction module 114 then extracts the article from its printing platform or printing support. In the meantime, the CS collects the estimated time of completion which informs the timing of its signal to be sent to the next-in-line PM. Upon the part extraction module's 114 task completion, the CS signals the immediate IE to move the article towards the immediate inspection gate (IG) which performs the 3D scanning inspection technique upon the article. The CS then collects the raw scanning data results arising from the IG's inspection and compares the raw scanning data results with the 3D model and generates a Pass/Rework/Reject signal. The CS then signals the integrating elements (IEs) to (i) forward the Pass-article towards the surface treatment module 116, or (ii) return the Rework-article to the part extraction module 114, or (iii) redirect the Reject-article to the scrap receptacle 173.

Next, the process parameters are set for the surface treatment module 116. The surface treatment module 116 then modifies the article's surface and/or selective small areas. In the meantime, the CS collects the estimated time of completion which informs the timing of its signal to be sent to the next-in-line PM. Upon the surface treatment module's 116 task completion, the CS signals the immediate IE to move the article towards the immediate inspection gate (IG) which performs the laser measuring inspection technique upon the article. The CS then collects the surface roughness results arising from the IG's inspection and compares the surface roughness results with the article's specification and generates a Pass/Rework/Reject signal. The CS then signals the integrating elements (IEs) to (i) forward the Pass-article towards the cleaning module 118, or (ii) return the Rework-article to the surface treatment module 116, or (iii) redirect the Reject-article to the scrap receptacle 173.

Next, the process parameters are set, and the cleaning agent/medium is determined according to the nature of raw material, for the cleaning module 118. The cleaning module 118 then cleans the article. Upon the cleaning module's 118 task completion, the CS signals the immediate IE to move the article towards the immediate inspection gate (IG) which performs the blacklight imaging inspection technique upon the article. The CS then collects the spectrum results arising from the IG's inspection and compares the spectrum results with the relevant spectrum reference and generates a Pass/Rework/Reject signal. The CS then signals the integrating elements (IEs) to (i) forward the Pass-article towards the end of production pathway where the finished article is delivered and collected, or (ii) return the Rework-article to the cleaning module 118, or (iii) redirect the Reject-article to the scrap receptacle 173.

FIG. 22 shows a conceptual block diagram of an exemplary embodiment comprising nine production modules and the process pathways in view of the inspection's decision loops. Here, the description will follow the movement of an article pending in the embodiment, as well as its transformation and redirection in the branching process pathways. Actions performed by the components shown in FIG. 22 are automatically administered by the controlling software (CS).

In addition to the functionalities of the “supplementary” production modules 121, 123, 125, 129, the main distinctions between the embodiments according to FIG. 21 and FIG. 22 are: that following certain production modules 114, 116, 118, 125, the Pass-article may be forwarded to more than one subsequent production modules; and that following certain production modules 114, 116, 118, 121, 125, 127, 129 the Rework-article may be returned to more than one production modules. These alternative pathways add to the embodiment's complexity as well as production flexibility (e.g., additional branching pathways may be employed not only for additional production steps, but also for rerouting the pending article to avoid bottleneck, congestion, or conflicts) along with the importance of CS in the administration thereof. Naturally, handling of the Reject-articles is the same as that of the embodiment of FIG. 21: all are always redirected to the scarp receptacle 173, favorably along the shortest pathway when the loads and conflicts are considered. The following description on FIG. 22 will be focused on its notable differences from FIG. 21. The rest of the details are inherently apparent to a normally skilled person who has been informed of the previous parts of the present Detailed Description.

The actions performed by the additive manufacturing module 112, the part extraction module 114, the surface treatment module 116, and the cleaning module 118, along with the associated actions performed by the CS and the IEs and IGs sequenced immediately after those modules 112, 114, 116, 118 are substantially similar to the description put forth previously in connection with FIG. 21 and thus omitted for brevity. In connection with the below-described production modules 121, 123, 125, 127, 129, the CS performs the substantially similar actions: setting process parameters which governs that PM's action to be executed upon the article, collecting that PM's estimated time of completion to inform the operation of the next-in-line PM (unless that present PM is the final PM according to the production plan) and signals the immediate IEs to move the article exiting the said PM to the next-in-line IG or PM, as the case may be. The details of the CS's administration of those PMs will thus be omitted unless there is additional, specific action respective to the PM.

In this embodiment, the Pass-article exiting the part extraction module 114 and the IG immediately subsequent thereto may, according to the production plan governing that production cycle, be forwarded to the surface treatment module 116 or to the thermal/chemical treatment module 121. And the Rework-article exiting the part extraction module 114 and the IG immediately subsequent thereto may, according to the production plan governing that production cycle, be returned to the additive manufacturing module 112 or to the part extraction module 114.

In this embodiment, the Pass-article exiting the surface treatment module 116 and the IG immediately subsequent thereto may, according to the production plan governing that production cycle, be forwarded to the cleaning module 118 or to the surface finishing module 123. And the Rework-article exiting the surface treatment module 116 and the IG immediately subsequent thereto may, according to the production plan governing that production cycle, be returned to any one of the additive manufacturing module 112, the part extraction module 114, the surface treatment module 116, and the thermal/chemical treatment module 121.

In this embodiment, the Pass-article exiting the cleaning module 118 and the IG immediately subsequent thereto may, according to the production plan governing that production cycle, be forwarded to any other production modules 112, 114, 116, 121, 123, 125, 127, 129. And the Rework-article exiting the cleaning module 118 and the IG immediately subsequent thereto may, according to the production plan governing that production cycle, be returned to any one of the additive manufacturing module 112, the part extraction module 114, the surface treatment module 116, the cleaning module 118, the thermal/chemical treatment module 121, and the surface finishing module 123.

In this embodiment, the thermal/chemical treatment module 121 modifies the article's material properties. The IG immediately succeeding the thermal/chemical treatment module 121 performs image detection technique to collect the data on the article's surface color, which is then compared with the predefined color to determine the generation of Pass/Rework/Reject signal. The resulting Pass-article is always forwarded to the surface treatment module 116. And, according to the production plan governing that production cycle, the resulting Rework-article may be returned to any one of the additive manufacturing module 112, the part extraction module 114, and the thermal/chemical treatment module 121.

In this embodiment, the surface finishing module 123 modifies the article's surface characteristics. The IG immediately succeeding the surface finishing module 123 performs 3D scanning technique to collect the raw scanning data results, which is then compared with the 3D model to determine the generation of Pass/Rework/Reject signal. The resulting Pass-article is always forwarded to the cleaning module 116. And, according to the production plan governing that production cycle, the resulting Rework-article may be returned to any one of the additive manufacturing module 112, the part extraction module 114, the surface treatment module 116, the thermal/chemical treatment module 121, and the surface finishing module 123.

In this embodiment, the quality control module 125 checks the article's quality or characteristics. The IG immediately succeeding the quality control module 125 performs ultra-high-resolution technique to collect the article's detailed images, which is then compared with the article specification to determine the generation of Pass/Rework/Reject signal. According to the production plan governing that production cycle, the resulting Pass-article may be forwarded to any other production modules 112, 114, 116, 118, 121, 123, 127, 129; and the resulting Rework-article may be returned to any one of the additive manufacturing module 112, the part extraction module 114, the surface treatment module 116, the cleaning module 118, the thermal/chemical treatment module 121, the surface finishing module 123, and the quality control module 125

In this embodiment, the sterilization module 127 sterilizes the article. The IG immediately succeeding the sterilization module 127 performs chemical indicator testing technique to collect the indicator results, which is then compared with the indicator reference to determine the generation of Pass/Rework/Reject signal. The resulting Pass-article is always forwarded to labeling/packing module 129. And, according to the production plan governing that production cycle, the resulting Rework-article may be returned to any one of the additive manufacturing module 112, the part extraction module 114, the surface treatment module 116, the cleaning module 118, the thermal/chemical treatment module 121, the surface finishing module 123, and the quality control module 125.

In this embodiment, the labeling/packing module 129 sterilizes the article. The IG immediately succeeding the labeling/packing module 129 performs image detection and image processing techniques to collect the article's images, which is then analyzed and compared with the identity information to determine the generation of Pass/Rework/Reject signal. The resulting Pass-article is always forwarded to the end of production pathway, thereby delivering, or making available for collection, the finished article. And, according to the production plan governing that production cycle, the resulting Rework-article may be returned to any other production modules 112, 114, 116, 118, 121, 123, 125, 127.

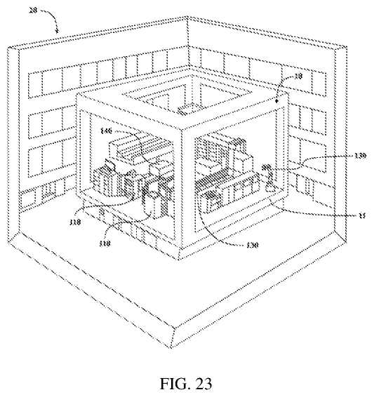

FIG. 23 shows a simplified cutaway drawing of an apparatus (10), designed for use within a clinical facility (20) or point of care, according to an exemplary embodiment. This depiction reveals the apparatus's internal composition, which includes several production modules (110), integrating elements (130), and inspection gates (140), all securely installed on the connector platform (11), and interconnected as described in previous embodiments. This embodiment is tailored for stationary use in a clinical setting, housed within a single container-potentially a modified standard 20-feet or 40-feet intermodal container. This design choice ensures the apparatus can be seamlessly integrated into the clinical facility's infrastructure, ready for immediate operation with minimal setup required beyond establishing power supply and information connectivity, thereby providing a compact, efficient solution for on-site medical device production and quality control within a healthcare environment.

### LIST OF REFERENCES

10 Apparatus for manufacturing a medical device
   10A Non-cleanroom space
   10B Cleanroom space
   11 Connector platform
   12 Door
   14 Airlock room
   16 Compartment wall
   18 Pass-box
20 Clinical facility
30 Truck
110 Production module
   112 Additive manufacturing module
   114 Part extraction module
   116 Surface treatment module
   118 Cleaning module
   121 Thermal/chemical treatment module
   123 Surface finishing module
   125 Quality control module
   127 Sterilization module
   129 Labeling/packing module
130 Integrating element (IE)
   131 Manual integration mode
   132 Semi-automatic integration mode
   133 Fully automatic integration mode
140 Inspection Gate (IG)
   141 First inspection mode
   142 Second inspection mode
   143 Third inspection mode
   144 Fourth inspection mode
   145 Fifth inspection mode
   146 Sixth inspection mode
   147 Seventh inspection mode
150 Controlling software
   152 Computer device
160 Information network
171 Inlet
172 Outlet
173 Scrap receptacle
1000 Process for manufacturing a medical device
   1100 Start
1200 System initialization
   1210 Checking system and detecting component
   1220 Establishing communication protocols
   1230 Configuring the component
   1240 Synchronization
   1250 Verifying operational readiness
1300 Article identification and planning
   1310 Receiving article's specification
   1320 Determining process steps
   1330 Checking capabilities of production module
   1340 Calculating the current operational efficiency
   1350 Optimizing time
   1360 Determining workflow sequence
   1370 Analyzing historical data
   1380 Generating production plan
1400 Production module assignment
   1410 Receiving the production plan
   1420 Analyzing the article's requirements
   1430 Dynamic selection of the production module
   1440 Preparing the production module
   1450 Configuring the route of integrating elements
   1460 Scheduling the inspection gate
   1470 Balancing the loads and resolving conflicts
1500 Integrating element assignment
1600 Production module running
   1610 Receiving the article's specifications
   1620 Setting up the production module
   1630 Running the production module
1700 Data collection
1800 Checking inspection requirements
1900 Inspection gate assignment
2000 Inspection gate running
   2010A Decision loop, passing inspection
   2010B Decision loop, failing inspection
2100 Process optimization
2200 Process termination
   2200A Delivering article
   2200B Disposing article

1. An apparatus for manufacturing a medical device, the apparatus comprising:
production modules independently configured to process the medical device, a medical device part, a medical device accessory, a medical device preform, or a raw material;
an integrating element configured to, between any two of the production modules, move the medical device, the medical device part, the medical device accessory, or the medical device preform; and
inspection gates independently configured to, outside the production modules, subject the medical device, the medical device part, the medical device accessory, or the medical device preform, to an inspection technique according to a predetermined inspection mode, and
operations of the production modules, the integrating element, and the inspection gates, are administered by a controlling software.

2. The apparatus according to claim 1, wherein each of the production modules are independently configured to process the medical device, the medical device part, the medical device accessory, the medical device preform, or the raw material, by performing a production technique that is independently selectable from any one or more of:
a first group comprising additive manufacturing, part extraction, surface treatment, cleaning, thermal or chemical treatment, and surface finishing;
a second group comprising quality control; and
a third group comprising sterilization, and labeling or packing, wherein
when two or more of the production modules are independently configured to perform two or more production techniques selected from different groups, the production modules are sequenced such that one or both of (i) and (ii) below are satisfied:
(i) the production techniques from the first group are always performed before the production technique from the second group and before the production techniques from the third group, and
(ii) the production technique from the second group is always performed before the production techniques from the third group, and
when two or more of the production modules are independently configured to perform two or more production techniques selected from the same group, the production modules are configured to be sequenced in any order.

3. The apparatus according to claim 2, comprising four or more of the production modules independently configured to perform at least the following production techniques: the additive manufacturing, the part extraction, the surface treatment, and the cleaning.

4. The apparatus according to claim 2, comprising five or more of the production modules independently configured to perform at least the following production techniques: the additive manufacturing, the part extraction, the surface treatment, the cleaning, and the thermal or chemical treatment.

5. The apparatus according to claim 2, comprising six or more of the production modules independently configured to perform at least the following production techniques: the additive manufacturing, the part extraction, the surface treatment, the cleaning, the thermal or chemical treatment, and the surface finishing.

6. The apparatus according to claim 2, comprising seven or more of the production modules independently configured to perform at least the following production techniques: the additive manufacturing, the part extraction, the surface treatment, the cleaning, the thermal or chemical treatment, the surface finishing, and the quality control.

7. The apparatus according to claim 2, comprising eight or more of the production modules independently configured to perform at least the following production techniques: the additive manufacturing, the part extraction, the surface treatment, the cleaning, the thermal or chemical treatment, the surface finishing, the quality control, and the sterilization.

8. The apparatus according to claim 2, comprising nine or more of the production modules independently configured to perform at least the following production techniques: the additive manufacturing, the part extraction, the surface treatment, the cleaning, the thermal or chemical treatment, the surface finishing, the quality control, the sterilization, and the labeling or packing.

9. The apparatus according to claim 2, wherein the additive manufacturing refers to a layer-by-layer manufacturing that is independently selectable from a group consisting of: laser-based printing, droplet-based printing, extrusion-based printing, powder bed fusion (PBF), direct metal laser sintering (DMLS), electron beam melting (EBM), selective heat sintering (SHS), selective laser sintering (SLS), direct metal laser melting (DMLM), binder jetting, material jetting, fused deposition modelling (FDM), fused filament fabrication (FFF), stereolithography (SLA), digital light processing (DLP), ink-based printing, laser-assisted printing, and direct energy deposition (DED).

10. The apparatus according to claim 2, wherein the part extraction refers to separating the medical device, the medical device part, the medical device accessory, or the medical device preform, from a printing platform or from a printing support, by a process that is independently selectable from a group consisting of: sawing, cutting, machining, grinding, vibration, etching, computer numerical control (CNC), laser-based extraction, chemical-based extraction, electro-chemical-based extraction, melting-based extraction, and dissolve-based extraction.

11. The apparatus according to claim 2, wherein the surface treatment is a process independently selectable from a group consisting of: blasting, polishing, grinding, vibration, tumbling, etching, CNC, laser-based treatment, chemical-based treatment, and electro-chemical-based treatment.

12. The apparatus according to claim 2, wherein the cleaning is a process independently selectable from a group consisting of: solution-based cleaning, chemical-based cleaning, electrochemical-based cleaning, air-based cleaning, washing, rinsing, ultrasonic washing, ultrasonic cleaning, vibration, air blowing, air steaming, UV cleaning, chemical etching, oil cleaning, acid cleaning, dissolving, and media blasting.

13. The apparatus according to claim 2, wherein the thermal or chemical treatment is a process independently selectable from a group consisting of: heating, annealing, sintering, conduction heating, convection heating, radiation heating, vacuum heating, laser heating, rapid heating, cyclic heating, laser curing, UV curing, light curing, homogenizing, chemical curing, gas curing, and cyclic chemical curing.

14. The apparatus according to claim 2, wherein the surface finishing is a process independently selectable from a group consisting of: mechanical polishing, wet electropolishing, dry electropolishing, chemical polishing, fine polishing, two-body abrasion, three-body abrasion, vibration, tumbling, and computer numerical control (CNC).

15. The apparatus according to claim 2, wherein the quality control is a process independently selectable from a group consisting of: caliper measuring, coordinate measuring, image detecting, image processing, 3D scanning, laser measuring, 2D profiling, 3D profiling, pin gauge measuring, atomic force microscope measuring, ultra-high-resolution imaging, blacklight imaging, ultraviolet imaging, and electron microscopy imaging.

16. The apparatus according to claim 2, wherein the sterilization is a process independently selectable from a group consisting of: steam sterilization, low temperature sterilization, X-ray sterilization, dry heat sterilization, ethylene oxide sterilization, and radiation sterilization.

17. The apparatus according to claim 2, wherein the labeling or packing is a process independently selectable from a group consisting of: laser marking, laser engraving, label printing, label affixing, sealing, thermo-plastic forming, box folding, pouch sealing, box sealing, and pelleting.

18. The apparatus according to claim 1, wherein the inspection mode covers an inspection subject that is independently selectable from a group consisting of dimension accuracy, surface roughness, cleanliness, and biological safety.

19. The apparatus according to claim 18, wherein:
the dimension accuracy is determined based on an inspection parameter independently selectable from a group consisting of: size, geometry, and physical characteristic, the inspection parameter being obtained from the inspection technique independently selectable from a group consisting of: caliper measuring, coordinate measuring, image detecting, image processing, 3D scanning, laser measuring, and pin gauge measuring; or
the surface roughness is determined based on the inspection parameter independently selectable from a group consisting of: surface characteristic, appearance, and porous characteristic, the inspection parameter being obtained from the inspection technique independently selectable from a group consisting of: 2D profiling, 3D profiling, laser profiling, atomic force microscope measuring, ultra-high-resolution imaging, blacklight imaging, ultraviolet imaging, 3D imaging, and electron microscopy imaging; or
the cleanliness is determined based on the inspection parameter independently selectable from a group consisting of: physical cleanliness, chemical cleanliness, and biological cleanliness, the inspection parameter being obtained from the inspection technique independently selectable from a group consisting of: ultra-high resolution imaging, blacklight imaging, ultraviolet imaging, electron microscopy imaging, total organic carbon testing, solution-based testing, atomic absorption spectroscopy (AAS), atomic emission spectroscopy (AES), atomic fluorescence spectroscopy (AFS), alpha particle x-ray spectroscopy (APXS), chromatography, differential scanning calorimetry (DSC), electron microscopy, energy dispersive spectroscopy (EDS/EDX), flow analysis, Fourier transform infrared spectroscopy (FTIR), gas chromatography (GC), high-performance liquid chromatography (HPLC), inductively coupled plasma (ICP), infrared spectroscopy (IR), laser induced breakdown spectroscopy (LIBS), mass spectroscopy (MS), optical microscopy, particle size analyzer (PSD), Raman spectroscopy, thermogravimetric analysis (TGA), X-ray photoelectron spectroscopy (XPS), X-ray diffraction (XRD), X-ray fluorescence spectroscopy (XRF), X-ray microscopy (XRM) and differential thermal analysis (DTA), biological indicator testing, and chemical indicator testing; or
the biological safety is determined using the inspection technique independently selectable from a group consisting of: cytotoxicity testing, hemolysis testing, limulus amoebocyte lysate bacterial endotoxin testing, bioburden testing, sterility testing and genetic toxicity testing.

20. The apparatus according to claim 1:
wherein the controlling software is hosted remotely from the apparatus, and is connectable thereto via an information network,
wherein, upon connecting the apparatus to the network, the apparatus performs administration of the operations of the at least two production modules, the integrating element, and the at least two inspection gates.

21. The apparatus according to claim 1, wherein the controlling software is further configured to administer: collection of operating data, monitoring of operating status, detection of operating failure, data storage analysis, decision-making in the operation, or transmission of data to or from an external computer device.

22. The apparatus according to claim 1, wherein the controlling software is further configured to administer at least one of the at least two production modules in performing a pre-production action before the medical device, the medical device part, the medical device accessory, or the medical device preform is moved into the at least one of the at least two production modules.

23. The apparatus according to claim 1, wherein the controlling software is further configured to cause at least one of the at least two production modules to change one or more process parameter applicable to the at least one of the at least two production modules.

24. The apparatus according to claim 1, further comprising a single container to encase all the at least two production modules, the integrating element, and the at least two inspection gates.

25. The apparatus according to claim 24 wherein the apparatus is adapted to operate as a cleanroom or further comprises a compartment that is adapted to operate as a cleanroom.

26. (canceled)

27. The apparatus according to claim 25, wherein the apparatus adapted to connect to another apparatus that adapted to operate as a cleanroom.

28. (canceled)

29. The apparatus according to claim 1, wherein at least two or more of the at least two production modules are positioned substantially vertically to each other.

30. The apparatus according to claim 1, wherein the apparatus is configured to be fitted or adapted to any available area of a clinical facility.

31. A clinical facility having the apparatus according to claim 1.

32.-42. (canceled)

43. The apparatus according to claim 1, wherein at least one of the at least two inspection gates is sequenced between any two of the at least two production modules.

44. The apparatus according to claim 43, wherein at least one of the at least two inspection gates is sequenced between two of the at least two production modules, two of the production modules being independently configured to process the medical device, the medical device part, the medical device accessory, the medical device preform, or the raw material, by performing a production technique that is independently selectable from any one or more of: additive manufacturing, part extraction, surface treatment, thermal or chemical treatment, surface finishing, quality control, and labeling or packing.

45. The apparatus according to claim 1, wherein the apparatus is constructed as a ready-to-transport compact unit.
